(19) United States
(12) Patent Application Publication
(10) Pub. No.: US 2022/0129816 A1
(43) Pub. Date: Apr. 28, 2022

(54) METHODS AND ARRANGEMENTS TO MANAGE REQUIREMENTS AND CONTROLS, AND DATA AT THE INTERSECTION THEREOF

(71) Applicant: State Street Corporation, Boston, MA (US)

(72) Inventors: Dushyant RALHAN, Boston, MA (US); Frank J. WALDRON, Boston, MA (US)

(73) Assignee: State Street Corporation, Boston, MA (US)

(21) Appl. No.: 17/508,556

(22) Filed: Oct. 22, 2021

Related U.S. Application Data
(60) Provisional application No. 63/104,659, filed on Oct. 23, 2020.

(51) Int. Cl. G06Q 10/06; G06F 40/205; G06F 40/40; G06N 5/04; G06N 5/02

(52) U.S. Cl. CPC G06Q 10/06315; G06F 40/205; G06N 5/025; G06N 5/04; G06F 40/40

(57) ABSTRACT

Logic may process documents, search documents, test controls, and self-heal control management. Logic may ingest and/or process requirements from documents and associate requirements with controls and/or other data types such as issues, events, test results, outputs, questions and answers (Q&As), and/or the like. Logic may train an ingestion engine to identify requirements. Logic may implement automatic control testing including inference and performance of remedial actions. And logic may include self-healing control management including inference of new controls based on uncorrelated requirements, inference of remedial actions based on the new controls, and performance of the remedial actions.

### CROSS-REFERENCE TO RELATED APPLICATIONS

This application claims the benefit of and priority to Provisional Application No. 63/104,659 entitled “METHODS AND ARRANGEMENTS TO MANAGE REQUIREMENTS AND CONTROLS” filed Oct. 23, 2020, which is hereby incorporated by reference in its entirety.

### TECHNICAL FIELD

Embodiments disclosed herein relate to the field of computer architecture and software to manage requirements and controls. More specifically, embodiments disclosed herein relate to implement machine learning to analyze documents to identify requirements; associate the requirements with existing or new controls; automate testing of the controls; and apply remedial measures based on gaps detected.

### BACKGROUND

Large organizations establish rules or guidance for operation of the organizations and establish processes and controls to manage risk while performing tasks related to the operation of the organizations. The tasks may involve internal requirements such as policy and operating procedures or may follow guidance offered through other organizations or government agencies such as regional regulations, industry standards, cybersecurity standards, and/or the like.

Such large organizations may hire employees, groups of employees, and/or outside consultants to review the rules and guidance and may establish controls to follow obligations from the rules and guidance. Such controls may include, for example, establishment of configurations and settings, maintenance of software licenses, obligations to install and configure specific versions of software packages on various computers such as servers, workstations, laptops, and/or the like.

Organizations practicing risk management typically follow a repeating four step process for all instances where risk is inherent. The four step process typically includes steps for risk identification, risk assessment, risk mitigation, and risk monitoring. Risk management also integrates reporting into one or more of the steps. As complexity grows within an organization, so too does the opportunity for inherent risk requiring large investments in people and technology to implement an effective risk management process.

### BRIEF DESCRIPTION I/F THE DRAWINGS

FIG. 1A depicts hardware components of a system for control management.

FIG. 1B depicts hardware components of an apparatus for control management.

FIG. 1C depicts logic circuitry for control management.

FIG. 1D depicts an example of a neural network as a machine learning model for training and inference to implement functionality for control management.

FIG. 1E illustrates an embodiment of a graphical user interface of a dashboard to organize and present collected data as well as AI derived predictions related to risk involved with business activities.

FIG. 2 illustrates another embodiment of logic circuitry for control management.

FIG. 3A illustrates an embodiment of a flowchart for a processing model to process documents.

FIG. 3B illustrates an embodiment of a flowchart for a processing model to search documents to answer queries.

FIG. 3C illustrates an embodiment of a flowchart for training a processing model to identify obligations.

FIG. 3D illustrates an embodiment of a flowchart for training a processing model to determine search results responsive to a query.

FIG. 3E illustrates an embodiment of a flowchart for a control testing model.

FIG. 3F illustrates an embodiment of a flowchart for a self-healing, control management model.

FIG. 4 depicts an embodiment of hardware components of an apparatus for control management.

FIG. 5 illustrates an embodiment of a storage medium for control management.

FIG. 6 illustrates an embodiment of a computing platform for control management.

FIG. 7 illustrates an embodiment of a computer architecture for control management.

FIG. 8 illustrates an operating environment for processing models.

FIG. 9 illustrates an embodiment of a logic flow for processing models.

FIG. 10 illustrates an embodiment of another logic flow for processing models.

FIG. 11 illustrates another operating environment for processing models.

FIG. 12 illustrates another operating environment for processing models.

FIG. 13 illustrates another operating environment for processing models.

FIG. 14 illustrates another operating environment for processing models.

FIG. 15 illustrates another operating environment for processing models.

FIG. 16 illustrates an embodiment of another logic flow.

FIG. 17 illustrates an embodiment of another logic flow.

FIG. 18 illustrates another operating environment for processing models.

FIG. 19 illustrates an embodiment of another logic flow for processing models.

FIG. 20 illustrates an embodiment of another logic flow for processing models.

FIG. 21 illustrates an embodiment of another logic flow for processing models.

FIG. 22 illustrates an embodiment of another logic flow for processing models.

FIG. 23 illustrates an embodiment of another logic flow for processing models.

### DETAILED DESCRIPTION

Organizations may devote a large amount of resources determining requirements and controls to mitigate the risk associated with a failure to perform the requirements. Regional regulations, industry standards, cybersecurity standards, and the like may include updates or publications of revisions of the regulations and/or standards periodically. Such revisions may include new requirements as well as revised requirements and existing requirements. For example, highly regulated industries are typically required to file several regulatory assessments every year. The process of filing regulatory assessments is complex and time-limited, requiring skilled information technology (IT) and risk compliance professionals to prepare responses, in addition to several iterations of information gathering, and quality checks. Such professionals must wade through volumes of rules, laws, and/or the like to determine which regulations apply to their particular organization and/or operating conditions. Conventional systems for responding to and organizing regulatory responses are highly inefficient and resource intensive.

Once organizations establish controls to address requirements derived from internal and external guidance, such organizations ensure compliance with the controls by testing the controls. Testing the controls may involve, for example, manually reviewing log files, configurations, settings, and software versions of software installed on servers maintained by the organizations. The process of verification of the compliance becomes formidable as the numbers of servers and types of settings and/or configurations increase. For instance, a large organization may have thousands of servers and each server may comprise hundreds of individual server hardware components and/or server software applications and server application components subject to controls. In such embodiments, large organizations find it infeasible to verify controls for hundreds of individual server hardware components and/or software applications of each server. Thus, such large organizations may determine an appropriate sample size of the servers to verify to balance verification of compliance with risk associated with non-compliance.

IT organizations have many hundreds of processes. As a further example in the process space, organizations may have operating procedures for, e.g., on-boarding and terminating employees and contractors. Such organizations may establish controls for on-boarding and terminating employees and contractors for various reasons including the protection of sensitive or proprietary data. On-boarding and terminating employees and contractors, for instance, may involve requirements such as adding or removing access within a certain period of time or after training or exit interviews related to protection of sensitive or proprietary data. Currently, structures for testing controls for on-boarding and terminating employees and contractors may involve manual review of the processes.

Embodiments disclosed herein provide techniques, processes, and/or apparatus for requirement and control management, as well as management of data at the intersection requirements and controls. Some embodiments process documents of one or more different document types such as operating procedures, company policy, regulations, industry standards, and other standards such as cybersecurity standards. In such embodiments, the documents are processed to recognized text, as needed, and to generate a set of requirements such as regulatory and statutory obligations or inferred obligatory language.

Some embodiments may include processing model(s) to implement a text categorization process using machine learning (ML) and/or artificial intelligence (AI) technologies to automate the process of locating, categorizing, and/or organizing categorized text. Some embodiments may implement a text categorization process to efficiently and effectively respond to regulatory assessments, and thematically organize regulations.

Some embodiments may implement a data association process to efficiently and effectively link a requirement to a control to a point (e.g., activity or event) on a business or technology process and further link all associated data generated at that point. Some embodiments may analyze all data collected at such a point to identify insights within the data. In some embodiments, a text categorization process may identify categorized text (for instance, regulatory text), aggregate and summarize located text (for instance, classifying regulatory obligations by taxonomies), and/or discover and summarize similar text (for instance, similar regulations that may be summarized into rationalized obligations across several regulatory sources).

Some embodiments disclosed herein implement machine learning to analyze documents to identify requirements including regulatory obligations and non-regulatory requirements and to automate the association of: the obligations with requirements from industry standards; existing or new controls; and all data related to the intersection of regulatory obligations, other requirements, and controls. Some embodiments analyze the data to identify gaps in controls and differentiate normal gaps from anomalous gaps. Some embodiments automate testing of the controls and apply remedial measures based on gaps detected in the resulting data sets.

Some embodiments may train artificial intelligence (AI) such as a machine learning model to differentiate (from other types of input), capture, and map current practices via policy, process, and procedure documentation. Current practices represent the business processes in place and, as a holistic library of practices, such libraries contain the spectrum of individual activities that occur within a business.

Some embodiments may train AI such as a machine learning model to identify the individual activities within a practice. Every activity has inherent risk and is subject to a mitigating control. Each of these activities generates data in some form and this data may be associated with the activity and tracked by AI.

Some embodiments may implement a data association process to efficiently and effectively link a requirement to a control to an activity point on a business or technology process. Such embodiments may further link all associated data generated at that activity point.

Some embodiments may be integrated with data generation systems such as Service Now or other commercial network, operations, and security log capturing systems. Such embodiments may capture generated data and identify the activities to which the data relates.

Some embodiments may be integrated into an output of a business process. Such business processes may generate files, database entries, database queries, messages, acknowledgements, gets, puts, writes, deletes, etc. Such embodiments may capture generated data and identify the activities to which the data relates.

Some embodiments may flag activities that do not have predicted or assigned correlating requirements and may flag requirements that do not have predicted or assigned correlating activities. Such embodiments may connect these gaps via machine learning models with, e.g., supervised learning.

Some embodiments may leverage and analyze the data collected at these points to correlate with expected outcomes to help answer questions such as “are these activities expected and appropriate”, “are these activities being operated as expected”, “is the performance as expected”, and over time determine what is normal versus a deviation from normal. If a deviation from normal is detected, such embodiments may flag the circumstance and associated data.

Some embodiments may analyze data leading up to events that deviate from normal to capture anomalous events within the data. Such embodiments may predict and flag data patterns that may indicate future deviations from normal prior to such future deviations from normal.

Some embodiments may include supervised learning of one or more machine learning models to set Key Risk Indicators (KRIs) for individual events to help identify when deviation from normal is acceptable versus when deviation from normal should be flagged. Identifying when deviation from normal is acceptable versus when deviation from normal should be flagged may be accomplished by identifying one or more specific patterns of events that are or are not evidence of increased risk.

Some embodiments may generate output as the result of a query to present output related to that query on a dashboard. Such embodiments may present the output as specific data related to an activity and/or any KRIs, anomalous flags, predicted future activities, or the like, related to the activity.

Once identified, some embodiments may map or correlate requirements to a set of existing controls. Controls may define a configuration, setting, software version, and/or the like that are required for mitigation of risk related to failure to comply with requirements. Controls may also define inventories to create and maintain and/or other actions required for mitigation of risk. Many embodiments generate a list or other data structure to identify unmapped requirements, or requirements that do not correlate to existing controls.

Some embodiments test controls automatically or autonomously by organizing controls into groups and engaging robots to perform testing to verify that the controls are implemented in hardware and software resources, within processes, or within the organization. The robots may include a software robots (also referred to as “bots” or “software agents”) or physical robots to perform physical actions in accordance with instructions. For instance, employment of an employee may involve a set of requirements in the form of actions including provision of hardware resources, installation of general employment software packages as well as position-specific software packages, provision of access to general employment and position-specific network resources, configuration of access to physical and hardware resources during specified hours during a day and specified days during a week, registration of security clearance for access to a physical building and an office, and/or the like. Many embodiments may establish controls for each action that include the action(s) to be performed and the time frame within which to perform the action(s).

Testing the controls associated with hiring an employee may involve checking for the implementation of each control in corresponding resources. For instance, embodiments may check the hardware resource such as a workstation or computer for installation of the software packages specified in the controls. Embodiments may check for registration of a badge for the employee and the association of specific security clearances with that badge in badge management software of a server or in a database or other data structure on a data server. Embodiments may verify time restrictions on the security clearances for access to computers, servers, offices, and buildings. Furthermore, embodiments may verify access authorizations and configurations established for general-employment and position-specific, network-based software applications and databases.

Some embodiments include machine learning query engines, also referred to as query models, to facilitate queries of collected data such as previous responses, requirements, and controls to generate current responses to, e.g., regulatory assessments. For instance, some embodiments may train a machine learning search engine (or search model) with queries from, e.g., regulatory assessments as well as responses from one or more different groups within the organization tasked to respond to the regulatory assessments. With the information such as user and organization information about the different groups tasked to respond, text associated with requirements, controls associated with the requirements, responses prepared by the different groups, and the queries; the machine learning search engine may learn to determine one or more responses to queries. In several embodiments, the machine learning search engine may learn to determine different responses to a query based on user information associated with the query. In some embodiments, the machine learning search engine may learn to determine different responses to a query and present the responses to a user to select an appropriate response to the query. In such embodiments, the machine learning search engine may learn to determine a response to a query based on user information associated with user feedback related to responses generated by the machine learning search engine. The feedback may include selection of a response for a query and/or ranking of one or more responses to a query.

Once the machine learning search engine is trained, the machine learning search engine may operate in inference mode to prepare responses to subsequent regulatory assessments. In some embodiments, the machine learning search engine may continue to learn to determine responses to queries based on feedback from one or more users or user groups responsive to responses prepared by the machine learning search engine operating in inference mode. In some of these embodiments, the machine learning search engine operating in inference mode may gather at least some supporting data and/or links to supporting data to provide to a user or group of users to facilitate verification of the responses generated by the machine learning search engine operating in inference mode.

Many embodiments may test controls through a software agent and/or robotics. For instance, some configurations, settings, log files, and/or the like may be accessible on a server by a software agent installed on a remote computer or via a software agent installed locally or that can be installed locally on the server. In such situations, the software agent may access, e.g., configurations on the server and one or more servers or computers to verify that actual configurations of hardware and/or software conform to the configurations specified in the corresponding controls. Further some configurations, settings, log files, and/or the like may only be accessible through physical access of a server or computer. Such embodiments may engage robotics to perform verifications. Some embodiments may also generate one or more reports summarizing hardware and/or software configurations, settings, log files, and/or the like accessed for verification specified in the corresponding controls and may include an indication of compliance or non-compliance to facilitate verification by a user or provide supporting evidence of verification specified in the corresponding controls for a user.

Several embodiments automatically and autonomously perform testing of controls. Such embodiments may request exclusive and/or non-exclusive access to certain resources, as needed, to avoid interruption of other operations. Such embodiments may also or alternatively schedule access to hardware and network resources to avoid conflicts that may cause undue delays in other operations.

Many embodiments automatically and/or autonomously implement self-healing operations to update requirements from new or updated documents, associate requirements with existing controls, determine gaps in compliance, notify responsible parties, and take corrective actions in response to the gaps in compliance. In some embodiments, the gaps in compliance may include new or updated requirements that do not map to existing controls. As a result, one or more requirements may not have controls to mitigate risk of non-compliance by the organization. Some embodiments identify requirements that are not mapped to controls and infer new controls to mitigate risk via one or more self-healing model(s).

In some embodiments, the self-healing model(s) may infer a risk or assess a risk based on requirements that do not correlate to existing controls. In some embodiments, the risk may comprise a classification, a probability, an impact or the like. For instance, tags or labels associated with requirements from documents that identify the source of the requirements may factor into a risk assessment. Based on the risk, the self-healing model(s) may infer one or more new controls to correlate with the uncorrelated requirements, infer one or more remedial actions to implement the one or more new controls, and perform the one or more remedial actions. Note that tags generally describe any information, data, metadata, index, offset, word, or phrase used to associate text such as requirements with categories such as user groups, specific users, employment categories of users, document types, requirements categories, and/or any other way to categorize the item with which the tags are associated. Labels as discussed herein are defined as tags.

In some embodiments, the self-healing model(s) may infer a risk or assess a risk based on training. For instance, a machine learning model of the self-healing model(s) may be trained with data that associates risks with requirements and/or controls such as a risk library that defines or describes information about various risks and/or levels of risks and a control library that defines or describes information about various controls or levels of controls. In some embodiments, the machine learning model may be trained to determine a probability associated with a risk or to classify a risk based on data including prior risk assessments for various requirements and/or controls. In further embodiments, different machine learning models may be trained to infer risk assessments for each risk in the set of one or more risks. In other embodiments, each machine learning model trained to infer risk assessments associated with requirements and/or controls, may infer risk assessments for a set of two or more risks.

In some embodiments, machine learning models may tie risk domains and business domains together by collecting risk and business data for analysis at very specific points of activity within a business or technical process. There may be many thousands of such points. These points within a process are defined by their Risk which is characterized by requirements and controls defined over time and documented in Jurisdictional Authoritative Sources, Industry Standards, Company Policies and other resources. Such associations between risk and business data may be predicted and confirmed by one or more machine learning models in a supervised learning manner. A machine learning system may advantageously bring all these concepts together plus the ability to collect the data occurring at these points to organize and provide insights. For instance, a machine learning model may be trained for analysis of data at a single point or a group of points of activity within a business or technical process.

Some embodiments implement a situational awareness dashboard as it relates to a query. The dashboard may organize and present collected data as well as make AI derived predictions based on the collected data related to risk involved with business activities.

In many embodiments, the self-healing model(s) may provide the one or more new controls to the control testing model(s) so the control testing model(s) can infer remedial actions and perform the remedial actions via robots as needed.

In several embodiments, the self-healing model(s) may include a machine learning engine, or model, to associate a new control with one or more hardware resources and/or one or more groups of hardware resources. For instance, an embodiment may associate a new control with a group of servers that associate or are associated to perform an engineering function such as three-dimensional modeling of an industrial structure or an accounting function such as an audit. In some embodiments, the one or more new controls may be associated with one or more tags (or labels) that identify hardware resources or groups of hardware resources. In such embodiments, the control testing model(s) can identify the server based on the one or more tags associated with a control, verify compliance with the one or more new controls by the servers, and/or determine and implement remedial actions to bring the servers in compliance with the one or more new controls.

In this description, numerous specific details, such as component and system configurations, may be set forth in order to provide a more thorough understanding of the described embodiments. It will be appreciated, however, by one skilled in the art, that the described embodiments may be practiced without such specific details. Additionally, some well-known structures, elements, and other features have not been shown in detail, to avoid unnecessarily obscuring the described embodiments.

In the following description, references to “one embodiment,” “an embodiment,” “example embodiment,” “various embodiments,” etc., indicate that the embodiment(s) of the technology so described may include particular features, structures, or characteristics, but more than one embodiment may and not every embodiment necessarily does include the particular features, structures, or characteristics. Further, some embodiments may have some of, all, or none of the features described for other embodiments.

As used in this description and the claims and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

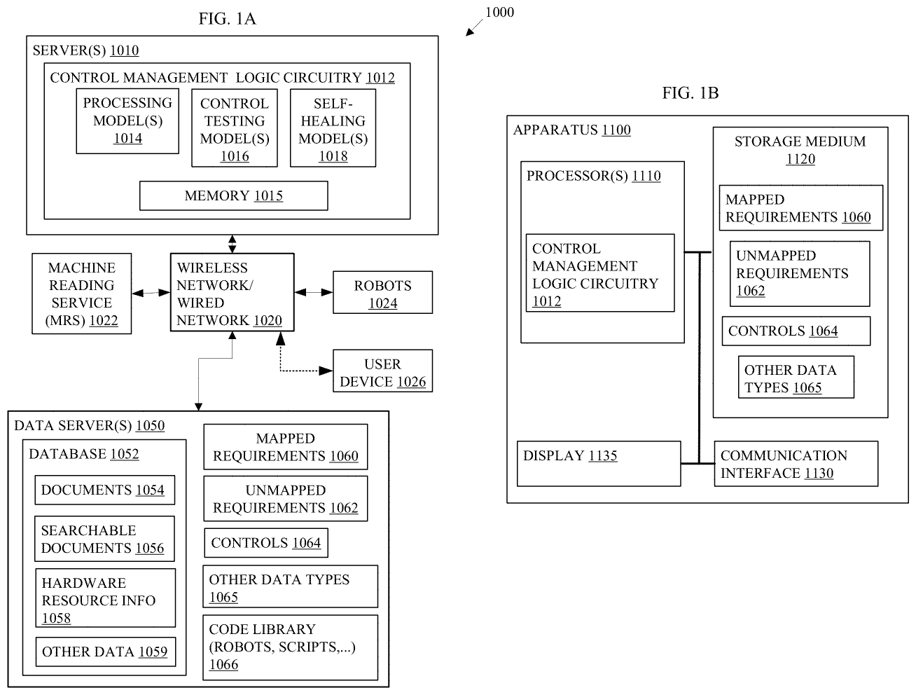

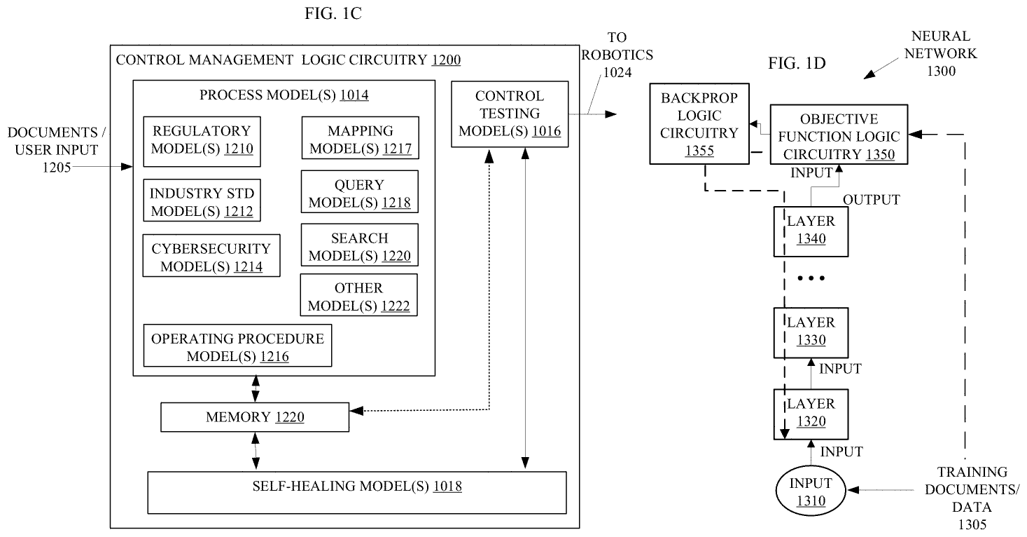

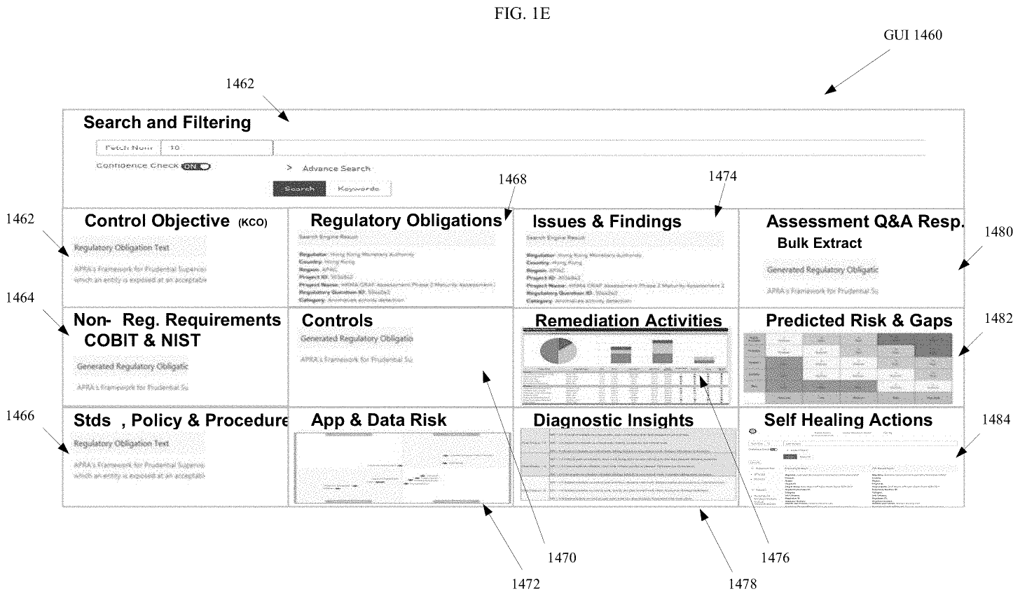

Turning now to the drawings, FIGS. 1A-C depict embodiments of systems, apparatuses, logic circuitry, and models including servers, networks, data servers, and software applications to manage requirements, controls, and associated data. FIG. 1A illustrates an embodiment of a system 1000. The system 1000 may represent a portion of at least one wireless or wired network 1020 that interconnects server(s) 1010 with data server(s) 1050. The at least one wireless or wired network 1020 may represent any type of network or communications medium that can interconnect the server(s) 1010 and the data server(s) 1050, such as a Ethernet, Gigabit Ethernet, fiber, cellular service, a cellular data service, satellite service, other wireless communication networks, fiber optic services, other land-based services, and/or the like, along with supporting equipment such as hubs, routers, switches, amplifiers, and/or the like.

In the present embodiment, the server(s) 1010 may represent one or more servers owned and/or operated by a single company or organization. In some embodiments, the server(s) 1010 represent more than one company that provides services. The server(s) 1010 may comprise control management logic circuitry 1012 and the control management logic circuitry 1012 may include processing model(s) 1014, memory 1015, control testing model(s) 1016, and self-healing model(s) 1018. The control management logic circuitry 1012 may reside on a single server of the server(s) 1010, may be distributed as different portions on more than one of the server(s) 1010, and/or may be distributed as more than one copies of the same and/or overlapping portions of the control management logic circuitry 1012 on more than one of the server(s) 1010.

The model(s) may comprise algorithms or machine learning models such as statistical models, neural networks or other machine learning models. In many embodiments, the processing model(s) 1014 may include natural language processing or other language processing to process documents such as operating procedures, regulatory texts or code, industry standards, cybersecurity standards, and/or the like, to identify statements that include requirements. In some embodiments, the processing model(s) 1014 may identify, aggregate and rationalize content from regulatory manuals into regulatory obligations, classes of obligations (based on industry standard taxonomies), summaries of long texts of obligations, regulatory question-answers, and controls in support of those obligations. In many embodiments, the processing model(s) 1014 may identify, aggregate and rationalize content from other documents such as industry standards, cybersecurity standards, and/or other standards, to identify requirements and classify the requirements into classes of requirements.

Classification of the requirements such as industry requirements and regulatory obligations may involve associating tags, or labels, with the corresponding text. For instance, some regulatory texts may reference or adopt one or more industry standards such as National Institute of Standards and Technology (NIST) standards, Federal Information Security Management Act (FISMA) standards, Federal Risk and Authorization Management Program (FedRAMP) standards, Defense Federal Acquisition Regulation Supplement (DFARS) standards, Criminal Justice Information Services (CJIS) standards, Health Insurance Portability and Accountability Act (HIPAA) standards, and/or the like. As such, regulatory obligations and one or more requirements in industry standards may overlap and, thus, controls to mitigate risk associated with the regulatory obligations and industry requirements may be related or even overlap. Such requirements may be associated with one or multiple documents such as operating procedures, regulations, industry standards, and/or the like with one or multiple tags. The tags may identify a single type of document or may represent a combination of documents. In some embodiments, the requirements or obligatory text may be associated with individual type of documents via tags as well as common combinations of the documents via tags.

The processing model(s) 1014 may be advantageously trained to parse the documents 1054 into sections and statements, identify previously found requirements, and identify and analyze new or revised sections and/or statements. The processing model(s) 1014 may aggregate text with similar requirements and, in some embodiments, determine new requirements from the text.

Several embodiments comprise a machine reading service (MRS) 1022 to interpret the documents 1054 as needed. The machine reading service (MRS) 1022 may, for example, include an optical character recognition (OCR) based service to convert images of text into searchable text and, in some embodiments, add metadata as tags to identify text that includes words or phrases or content more generally that may be useful when searching the text. In some embodiments, searchable versions of the documents including metadata is stored in searchable documents 1056. In other embodiments, the searchable documents do not include metadata.

In some embodiments, the processing model(s) 1014 may include one or more models per a particular document. Processing model(s) 1014 that are specifically trained to process a particular standard or regulatory text may, advantageously, provide more in-depth analyses of such documents. For instance, the processing model(s) 1014 may include one model for a regulatory text for a particular regulatory jurisdiction or one or more models for a particular industry standard or cybersecurity standard. In some embodiments, a processing model may be specifically trained to identify FedRAMP obligations using metadata specific to the FedRAMP document. In some embodiments, a processing model may be specifically trained to identify regulatory or statutory obligations in one or more sections of a statutory or regulatory document and one or more additional processing models may be specifically trained to identify regulatory or statutory obligations in one or more sections of the remaining sections of the statutory or regulatory document.

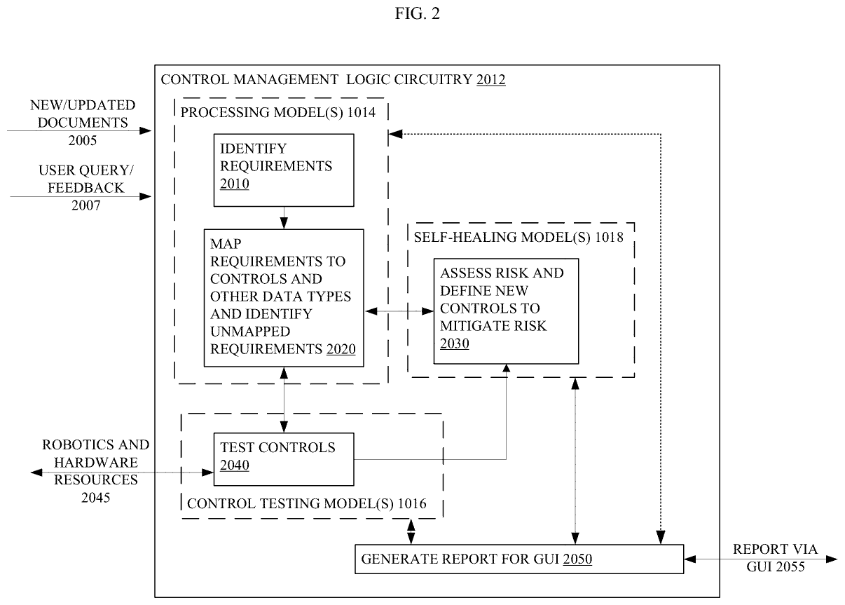

In some embodiments, the processing model(s) 1014 may interact with a user at a user device 1026 by providing the user with the inferred requirements and receiving feedback to confirm that the text includes the requirements or to determine that the text does not include requirements. In such embodiments, the processing model(s) 1014 may continue to learn to identify requirements in the text of the documents based on feedback from the user. For instance, the processing model(s) 1014 may transmit summarized text or one or more excerpts of text from a document related to a requirement to the user device 1026 to present the requirement to a user for confirmation that the text represents a requirement. The user device 1026 may present the summarized text or one or more excerpts of text from the document on a display of the user device 1026 and request input from the user. In some embodiments, the summarized text or one or more excerpts of text from a document related to a requirement to the user device 1026 may be presented in a graphical user interface (GUI) such as the GUI 2060 shown in FIG. 2B and a user of the user device 1026 may provide feedback via the GUI.

After receipt of the input from the user, the user device 1026 may transmit the input to the processing model(s) 1014 and one or more of the processing model(s) 1014 may backpropagate the input from the user to learn from the feedback. In some embodiments, the processing model(s) 1014 may only backpropagate negative feedback from the user (e.g., the text does not represent a requirement). In other embodiments, the processing model(s) 1014 may only backpropagate positive feedback from the user (e.g., the text does represent a requirement). In further embodiments, the processing model(s) 1014 may backpropagate both positive and negative feedback from the user.

In other embodiments, documents such as industry standards and regulatory texts may be interpreted by the same processing model(s) 1014 or multiple instances of the same processing model(s) 1014. Processing model(s) 1014 that are more generally trained to identify requirements in multiple different documents can, advantageously, process other types of documents without pretraining or retraining.

The processing model(s) 1014 may be advantageously trained to access a set of existing controls 1064, and/or other data types 1065, and correlate the one or more requirements inferred from the one or more documents with the set of existing controls 1064, and/or other data types 1065 such as issues, events, test results, outputs, questions and answers (Q&A), and/or the like. The processing model(s) 1014 may aggregate text with similar requirements and, in some embodiments, determine new requirements from the text.

In some embodiments, one or more of the documents may include a complete text of the document that has been revised to include new requirements and/or revised requirements. In some embodiments, the processing model(s) 1014 may correlate the texts of the current version of the document with the previous version of the document to determine residual text. Such processing model(s) 1014 may analyze the residual text in the context of the entire document to identify the new and/or revised requirements.

In some embodiments, the processing model(s) 1014 may analyze the residual text in the context of the entire document to identify the deleted and/or repealed requirements and a list of repealed or deleted requirements may be presented to a user via a GUI of the user device 1026. In such embodiments, the self-healing model(s)s 1018 may recommend and/or perform deletion of the requirement from the mapped requirements 1060 and/or the unmapped requirements 1062. In some embodiments, the self-healing model(s)s 1018 may determine a lack of a need for one or more of the controls 1064 in response to identification of the deleted and/or repealed requirements and may recommend and/or perform deletion of the one or more of the controls 1064.

As an illustration, in some embodiments, the processing model(s) 1014 may parse documents via a natural language processor (NLP) into individual statements with requirement prediction (inference), implement supervised learning to correct incorrect predictions, segregate non-correlated requirements where a gap in the controls exist, and store the segregated requirements in an enabling data structure. Parsing the documents may involve inferring (predicting) requirements from the parsed documents, ingesting controls, correlating requirements with each other and controls and groups of associated requirements with associated controls, and storing the correlated requirements and controls and groups of associated requirements with associated controls in an enabling data structure.

In many embodiments, the processing model(s) 1014 may also associate the requirements and/or controls with other data types 1065. In some embodiments, the processing model(s) 1014 may associate the requirements and controls with issues, events and incidents, test results and evidence, outputs, questions and answers (Q&A), and/or the like. The issues may involve, for instance, detection of anomalies in an activity or in a group of activities. Activities may generate intended or expected data as well as unintended or unexpected data. The group of activities, such as transactions, within a certain time frame or regard to a certain account or investment or set of accounts and investments, may be associated with a risk. The risk may be associated with a risk value as well as one or more risk thresholds. Some embodiments may associate the issue along with the risk value and/or risk thresholds with a requirement related to the issue and a control implemented to manage the requirement.

The events may comprise, e.g., Information Technology Service Management (ITSM) events related to one or more requirements and controls. In some embodiments, the events may include assignments of software or hardware resources to one or more users or groups of users, change requests, release requests, activity assignments to one or more users or groups of users, problem investigations, task assignments, asset management, license management, and/or the like, and status changes therefor.

The test results may include, e.g., test results from automated testing of controls such as controls for regulatory obligations. For instance, the test results may include the software applications installed and versions of the software applications installed on the user device 1026. Further embodiments may test controls for authorizations associated with users having access to the user device 1026.

The outputs may include, e.g., outputs associated with one or more business activities associated with one or more requirements and controls. For instance, certain business activities may be associated with requirements from regulatory texts and/or statutory texts. Outputs from the business activities such as transactions processed, number accounts accessed, values of the transactions processed, and/or the like, may be associated with the requirements and associated controls in the other types of data 1065. Some embodiments may include one or more machine learning models associated with the output data to monitor the data generated to identify patterns of latent & emerging risk.

The questions and answers (Q&As) may include Q&As associated with regulatory assessment reporting. Different jurisdictions may require reporting related to compliance with regulatory obligations and may provide questions to answer to verify or assess compliance with the regulatory obligations. The other data types 1065 may include answers generated in response to the questions as well as the questions for regulatory reports in one or more jurisdictions.

After correlating the one or more requirements inferred from the one or more documents with the set of existing controls, the processing model(s) 1014 may associate a set of the one or more requirements with the set of existing controls based on correlation of each requirement in the set of the one or more requirements with an existing control in the set of existing controls 1064. The processing model(s) 1014 may the store the set of the one or more requirements in the memory in a data structure, mapped requirements 1060, to associate each requirement in the set of the one or more requirements with one or more of the existing controls in the set of existing controls 1064. Further embodiments associate the mapped requirements 1060 and the controls 1064 with the other data types 1065 in one or more data structures in the other data types 1065, the mapped requirements 1060, and/or the controls 1064.

To illustrate, the processing model(s) 1014 may identify an obligation in FISMA to implement an information security control to, e.g., maintain a comprehensive hardware/software inventory. An associated control for this requirement may require the verification that hardware such as a server and software package versions installed on the server are included in a comprehensive database 1052 of hardware resource info 1058. The processing model(s) 1014 may gather one or more discussions related to maintenance of a comprehensive hardware/software inventory from the most recent update to the FISMA compliance in NIST 800-53. After analysis of the text related to the comprehensive hardware/software inventory, the processing model(s) 1014 may correlate one or more descriptions of the requirement with existing controls. The processing model(s) 1014 may, e.g., store information about hardware resources in the hardware resource info 1058 and store a summary of the requirement, the text associated with the requirement, and/or an indicator (such as a reference or address) for the requirement in the mapped requirements 1060 along with one or more tags to associate the requirements with the corresponding controls in controls 1064. If, for instance, the most recent update to the FISMA compliance in NIST 800-53 includes a new requirement to, e.g., maintain in the inventory, serial numbers for hard disk drives currently installed each computer and the controls 1064 do not include verification that the serial numbers of the hard disk drives in each computer are included in the hardware resource info 1058, the new requirement may be stored in a list of uncorrelated or unmapped requirement 1062. In other embodiments, the unmapped requirements 1062 may be included in the same data structure as the mapped requirements 1060 but may include a tag indicating that the requirement does not correlate to existing controls 1064. In still other embodiments, unmapped requirements 1062 may not be associated with a tag indicating an association with controls 1064.

The memory 1015 may comprise any one or more types of data storage media such as cache, non-volatile memory, volatile memory, flash memory, solid-state drives, hard disk drives, and the like. The memory 1015 may store excerpts of text, summaries of text, mapped requirements, unmapped requirements, controls, code or excerpts of code to execute, and/or the like. Some of the content in the memory 1015 may reside in the memory 1015 temporarily while awaiting execution; executing; transmitting to or from the data server(s) 1050, robots 1024, user device 1026, MRS 1022, and/or the like. The memory 2015 may also store input data for one or more of the processing model(s) 1014, control testing model(s) 1016, self-healing model(s) 1018, and/or the like.

As an illustration, the processing model(s) 1014 may training to compare requirements and comparing requirements identified in documents by the processing model(s) 1014; associate tags with the statements and requirements to associate the statements and requirements with particular types of documents; associate documents with requirements and other document metadata; store a data structure in memory to compare content with other classes of data; associate requirements and statement with jurisdictions; and associate requirements and statement with jurisdictions with Industry Standards.

The control testing model(s) 1016 may implement automatic control testing and, in some embodiments, autonomous and automatic control testing. The control testing model(s) 1016 may organize controls 1064 into groups, each group associated with a hardware resource, and engage robots 1024 to access the hardware resource. In some embodiments, engagement of the robots 1024 may comprise installation of one or more software agents on one or more servers to perform tasks or to create an environment such as a Blue Prism Robotic Process Automation (RPA) to perform tasks via scripts and Application Program Interfaces (APIs), or a kernel Virtual Machine (KVM) logical interactivity to perform the tasks.

In many embodiments, the software agents may operate autonomously and may engage other network services such as software services or hardware services to perform functionality such as accessing electronic files such as configuration files, settings files, log files, and/or the like to transmit to the control testing model(s) 1016 for verification. Some software agents may monitor a context of the system and self-initiate in an appropriate context to perform functionality. Some software agents may organize and prioritize operations to perform. Furthermore, some software agents may create local instances to execute on a server or computer to perform functionality locally. For instance, a software agent may be installed and executed to gather information for the control testing model(s) 1016. The software agent may receive a task from the control testing model(s) 1016 to gather log files from each server in a group of servers, gather related tasks for the group of servers such as collecting settings, and transmit the log files and settings from each server in the group of servers to the control testing model(s) 1016.

In some embodiments, engagement of the robots 1024 may comprise initiating code such as code from the code library 1066 and a robotic mechanism to physically manipulate the hardware resource and to access information in the hardware resource. In some embodiments, the code in the code library 1066 may comprise code for the robotics for a specific hardware resource such as a server, a specific location of the hardware resource (e.g., server) in a rack, and/or a specific type of hardware resource (e.g., server) to enable the robotics 1024 to access various information about hardware and software components installed in the hardware resource. For example, as part of the obligation to maintain a comprehensive inventory of hardware and software, the control testing model(s) 1016 may access the hardware resource info 1058 to determine a set of one or more servers to access, load code from the code library 1066 to access hardware and/or software components of the server via the robotics 1024, and load controls 1064 associated via one or more tags or the like with the set of one or more servers.

The robots 1024 may execute the code to access electronic files such as configuration files, settings files, log files, and/or the like to transmit to the control testing model(s) 1016 for verification. In further embodiments, the robots 1024 may execute the code to physically access and/or identify serial numbers, model numbers, part numbers, and/or the like of the hardware resource or hardware components installed on or within the hardware resource such as a solid-state drive installed in a server. Upon attaining physical access to serial numbers, model numbers, part numbers, and/or the like, the robots 1024 may use a scanner, camera, radio frequency identification (RFID) reader, magnetic stripe reader, near-field communications (NFC) transceiver or receiver, and/or the like to capture the serial numbers, model numbers, part numbers, and/or the like and to transmit the serial numbers, model numbers, part numbers, and or the like to the control testing model(s) 1016 for verification.

In some embodiments, when the robots 1024 captures information in the form of, e.g., a picture, the robots 1024 may transmit the picture with the one or more serial numbers, model numbers, part numbers, and/or the like to the control testing model(s) 1016 via the MRS 1022 or other service to convert the data collected into information that can be used by the control testing model(s) 1016 to verify compliance with a corresponding control.

The control testing model(s) 1016 may receive information collected from the hardware resource by the robots 1024 either directly or via a service such as the MRS 1022. The control testing model(s) 1016 may analyze the information collected from the hardware resource to determine differences between the information collected from the hardware resource and information expected based on a control associated with the hardware resource. For example, the control testing model(s) 1016 may compare a serial number stored in the hardware resource info 1058 for a solid-state drive installed in a specific server against the serial number returned from the robots 1024 for that specific server. The control testing model(s) 1016 may expect that the serial number for the solid-state drive stored in the hardware resource info 1058 would match the serial number returned from the robots 1024 for that solid-state drive. If the serial numbers match, the control testing model(s) 1016 may verify implementation of the control. On the other hand, if the serial numbers do not match or there is no corresponding serial number in the hardware resource info 1058 for the solid-state drive, the control testing model(s) 1016 may determine that the inventory in the hardware resource info 1058 fails to comply with the control.

For situations in which one or more of the control testing model(s) 1016 identifies a failure in compliance with one or more controls, the control testing model(s) 1016 may infer one or more remedial actions based on the differences and perform the one or more remedial actions. In the case of a serial number of a solid-state drive in a server is found but there is no corresponding entry in the hardware resource info 1058, there are a number of possible reasons that may be verified by the control testing model(s) 1016. For instance, the solid-state drive may have been added to the server after installation in a rack or a user may have failed to input the serial number of the solid-state drive upon installation in the server. One of the control testing model(s) may be trained to analyze the differences such as the lack of the serial number in the hardware resource info 1058 and pursue each possible reason for the non-compliance such as contacting a user associated with the installation of the server or with the most recent access to the server, searching a work order log for installation of the solid-state drive in the server (possibly via the robots 1024 or via a network connection to a corresponding server), searching purchase orders for a recent purchase of the solid-state drive, and/or the like. Other embodiments may not identify the reasons for noncompliance.

In response to the determination of non-compliance, the control testing model(s) 1016 may infer a remedial action. Such control testing model(s) 1016 may be trained to receive input data that describes the incident of non-compliance and determine a solution. For instance, the most common solution in the case that a serial number is missing from the hardware resource info 1058 for a server might be to add the serial number into the hardware resource info 1058 for the server. In such situations, the control testing model(s) 1016 may determine the remedial actions involved with adding the serial number of the solid-state drive for the server into the hardware resource info 1058 and perform the one or more remedial actions. For instance, performance of the remedial actions may involve adding the serial number into the hardware resource info 1058 for the server and generating a notifier and/or log to indicate the incidence of non-compliance as well as the remedial actions taken to place the inventory back into compliance.

In other situations, the control testing model(s) 1016 may determine that the remedial actions involve installation of a software package or a newer software version of a software package on a hardware resource such as a server. Performance of the remedial actions in such situations may involve initiating code and a software agent of the robots 1024 to install a software package, record the software package version in the hardware resource info 1058, log the incidence of non-compliance along with the remedial actions taken to bring the hardware resource into compliance with the corresponding control(s), and transmit a notifier to a user or the user device 1026 and/or save a log of the software package installation. In other embodiments, the software agent may generate a work order to install the new software package and to update the hardware resource info 1058.

In further embodiments, the control testing model(s) 1016 may perform remedial actions including, but not limited to, changing a hardware component of the hardware resource, updating a software application installed on a hardware resource, updating a configuration of the hardware resource, updating settings of a hardware resource, uninstalling a software application from a hardware resource, uninstalling a hardware component of the hardware resource, and/or a combination thereof.

In many embodiments, the control testing model(s) 1016 may include one or more models that organize controls in groups associated with the same set or sets of hardware resources, order access to the multiple hardware resources, and autonomously access the multiple hardware resources to verify implementation of controls. In some embodiments, the control testing model(s) 1016 perform testing of two or more of the controls 1064 in parallel. In some of these embodiments, the control testing model(s) 1016 may order testing to coordinate or avoid conflicts in the use of limited resources such as the robots 1024 associated with a group of the hardware resources.

In many embodiments, the control testing model(s) 1016 may autonomously update multiple hardware resources in response to determination of differences between actual configurations and settings and expected configurations and settings based on controls associated with the multiple hardware resources. In further embodiments, the control testing model(s) 1016 may autonomously access and update, as needed, the multiple hardware resources continuously.

The self-healing model(s) 1018 may access uncorrelated obligations and infer new controls for the uncorrelated obligations. For instance, the operating procedures for an organization may add a new requirement that the organization maintain a record/log of all personnel authorized to access each hardware resource maintained by the organization. The personnel may include employees, contractors, sub-contractors, etc. The self-healing model(s) 1018 may be trained to generate data structures in a database 1052 of the data server(s) 1050 to maintain inventories, lists, logs, etc. related to hardware resources and other required fields and to populate the data structure with the hardware resources or a subset of hardware resources subject to the requirement from the hardware resource info 1058. The self-healing model(s) 1018 may be trained to associate tags with other resources such as personnel and software packages in the new data structure.

In response to the new requirement, the self-healing model(s) 1018 may generate the new data structure with the hardware resources and fields to associate the hardware resources with software packages and associate the software packages with personnel authorizations for access to the software packages. The self-healing model(s) 1018 may generate the new control(s) to maintain the data in the new data structure. Thus, for a general pool of servers that are dynamically tasked to perform operations with specific software packages, the new data structure may include tags to associate personnel authorized to access one of the software packages as having access to the pool of servers. As another example, for servers tasked to handle certain financial transactions, the new data structure may include tags to associate each person authorized to access one of the servers tasked to handle the certain financial transactions.

In addition to establishing a new data structure in the database 1050 and generating a new control(s) to maintain the data in the new data structure, the self-healing model(s) 1018 may infer one or more remedial actions based on the new control(s) and perform the one or more remedial actions. In some embodiments, the one or more remedial actions may involve populating the new data structure with data already compiled elsewhere in the system 1000. In other embodiments, the one or more remedial actions may involve engagement of the robots 1024 to perform one or more of the remedial actions. For instance, the new obligation in a document such as new operating procedures may require segregation of services such that the same hardware resource (e.g., server) cannot perform activities associated with both a first service and a second service. The self-healing model(s) 1018 may be trained to handle segregation of services by uninstalling software packages associated with the second service from a first set of servers that perform the first service and installing those software packages on a second set of servers to perform the second service. In such embodiments, the self-healing model(s) 1018 may engage the robots 1024 to perform uninstallation of the second software package from the first set of servers that perform the first service and installing those software packages on the second set of servers to perform the second service.

In some embodiments, the self-healing model(s) 1018 may determine uncorrelated controls, controls that do not correlate to obligations, and retire the uncorrelated controls. For instance, a control may no longer be required in a new revision of a document for various reasons such as becoming obsolete as a result of changes to other obligations. In such embodiments, the self-healing model(s) 1018 may tag the uncorrelated controls as retired or delete the uncorrelated controls and generate a notification for a user and/or a log of the retirement of the controls.

In some embodiments, the self-healing model(s) 1018 may infer a risk associated with one of the uncorrelated obligations; determine if the risk exceeds a risk threshold; and if the risk exceeds the risk threshold, infer one or more new controls to correlate with the one of the uncorrelated obligations to mitigate the risk. For instance, one or more of the self-healing model(s) 1018 may be trained to assess the risk of non-compliance associated with a requirement based on documents associated with the requirement and/or other factors. In some embodiments, a risk assessment may involve a determination of a probability that non-compliance with an requirement will occur so the one or more of the self-healing model(s) 1018 may be trained to output a probability that a non-compliance event will occur if a corresponding new control is not generated to monitor compliance. Some requirement may require a new control to guarantee a low risk of non-compliance such as requirement that require the creation of a new inventory or the like. If the inventory is not being maintained, there is 100% probability of non-compliance.

If an existing control creates the inventory with the same information but the requirement for the existing inventory and the requirement for the new inventory were not correlated by the processing model(s) 1014, the self-healing model(s) 1018 may determine remedial actions to mitigate the risk of non-compliance as a result of the existence of the existing requirement to create the inventory. In such situations, the self-healing model(s) 1018 may determine that the risk is mitigated by associating the new requirement with the existing control.

In some embodiments, the self-healing model(s) 1018 may autonomously access controls mapped to requirement and uncorrelated requirement and infer new controls for the uncorrelated requirement. In some embodiments, the self-healing model(s) 1018 may autonomously infer the one or more remedial actions based on the new controls; and perform the one or more remedial actions, wherein the one or more remedial actions comprise engagement of robots 1024. In further embodiments, the self-healing model(s) 1018 may autonomously access and update, as needed, the multiple hardware resources continuously.

FIG. 1B depicts an embodiment for an apparatus 1200 such as one of the server(s) 1010 shown in FIG. 1A. The apparatus 1200 may be a computer in the form of a smart phone, a tablet, a notebook, a desktop computer, a workstation, or a server. The apparatus 1200 can combine with any suitable embodiment of the systems, devices, and methods disclosed herein. The apparatus 1200 can include processor(s) 1210, a non-transitory storage medium 1220, communication interface 1230, and a display device 1235. The processor(s) 1210 may comprise one or more processors, such as a programmable processor (e.g., a central processing unit (CPU)). The processor(s) 1210 may comprise processing circuitry to implement control management logic circuitry 1012 such as the processing model(s) 1014, control testing model(s) 1016, and/or the self-healing model(s) 1018 in FIG. 1A.

The processor(s) 1210 may operatively couple with a non-transitory storage medium 1220. The non-transitory storage medium 1220 may store logic, code, and/or program instructions executable by the processor(s) 1210 for performing one or more instructions including the control management logic circuitry 1012. The non-transitory storage medium 1220 may comprise one or more memory units (e.g., removable media or external storage such as a secure digital (SD) card, random-access memory (RAM), a flash drive, a hard drive, and/or the like). The memory units of the non-transitory storage medium 1220 can store logic, code and/or program instructions executable by the processor(s) 1210 to perform any suitable embodiment of the methods described herein. For example, the processor(s) 1210 may execute instructions such as instructions of the control management logic circuitry 1012 causing one or more processors of the processor(s) 1210 represented by the control management logic circuitry 1012 to manage controls.

The non-transitory storage medium 1220 may store code and data for the control management logic circuitry 1012 and store mapped requirements 1060, unmapped requirements 1062, and controls 1064 as shown in FIG. 1A. In some embodiments, the storage medium 1120 may also comprise a code library 1066 as shown in FIG. 1A.

The processor(s) 1210 may couple to a communication interface 1230 to transmit and/or receive data from one or more external devices (e.g., a terminal, display device, a smart phone, a tablet, a server, a printer, or other remote device). The communication interface 1230 includes circuitry to transmit and receive communications through a wired and/or wireless media such as an Ethernet interface, a wireless fidelity (Wi-Fi) interface, a cellular data interface, and/or the like. In some embodiments, the communication interface 1230 may implement logic such as code in a baseband processor to interact with a physical layer device to transmit and receive wireless communications such as instructions and/or code to a user device 1026 or robotics 1024 from a server or an instance of a neural network of the control testing logic circuitry 1012. For example, the communication interface 1230 may implement one or more of local area networks (LAN), wide area networks (WAN), infrared, radio, Wi-Fi, point-to-point (P2P) networks, telecommunication networks, cloud communication, and the like.

FIG. 1C depicts control management logic circuitry 1200 for control management such as the control management logic circuitry 1012 shown in FIG. 1A. In the control management logic circuitry 1200, the process model(s) 1014 include distinct machine learning models trained for each document. The models may include one or more regulatory model(s) 1210, one or more industry standard model(s) 1212, one or more cybersecurity model(s) 1214, and one or more operating procedure model(s) 1216.

The regulatory models 1210 include at least one model trained specifically for each distinct regulatory jurisdiction. The industry standard model(s) 1212 may include one or more models trained to process relevant industry standards. The cybersecurity model(s) 1214 may include one or more models trained to process relevant cybersecurity standards. And the operating procedure model(s) 1216 may include one or more models trained to process relevant operating procedures for one or more jurisdictions, one or more business units, and/or the like.

In the control management logic circuitry 1200, the process model(s) 1014 also comprise mapping model(s) 1217, query model(s) 1218, search model(s) 1220, and other model(s) 1222. The mapping model(s) 1218 may receive text of requirements with context of the document source or receive the complete document and predict or classify associations between the text of the requirement and existing controls stored in the memory 1220. In many embodiments, the mapping model(s) 1218 may also receive other data types from the memory or various sources and predict or classify associations between the existing controls and requirements.

The query model(s) 1218 may receive a query to perform a search related to an association between existing controls and requirements and parse the query and user information to form input data for a machine learning query engine. The search model(s) 1220 may receive an inference from the machine learning query engine, the query model(s) 1218, for one or more suggested queries based on the input data; infer search results based on the one or more suggested queries; and present search results based on the one or more suggested queries to a user. In many embodiments, the search model(s) 1220 may receive feedback from the user related to the search results based on the one or more suggested queries to a user and update training of one or more of the search model(s) 1220 (machine learning search engines) based on the feedback.

In some embodiments, updating the training of the machine learning search engine based on the feedback comprises updating the training based on a ranking of one or more of the search results by the user. In some embodiments, updating the training of the machine learning search engine based on the feedback comprises associating the updated training with the user information about the user, the user information to comprise group information to associate the user with one or more groups of users.

As an illustration, the search model(s) 1220 comprise an ability to query data stores, or enabling data structures, created by the processing model(s) 1014. The search model(s) 1220 may learn based on the metadata of the query i.e. who, specific wording of query, etc.; receive results; and rank results. Furthermore, the search model(s) 1220 may train engine via ranking, train engine via user information, and the processing model(s) 1014 may leverage optical recognition to ingest data.

FIG. 1D generally describes a way to train a neural network (NN) 1300 with supervision (supervised learning). FIG. 1D depicts an embodiment of a neural network (NN) 1300 of a control management logic circuitry, such as the models 1014, 1016, and 1017 in control management logic circuitry 1012 shown in FIG. 1A. The NN 1300 may comprise as a deep neural network (DNN).

A DNN is a class of artificial neural network with a cascade of multiple layers that use the output from the previous layer as input. An example of a DNN is a recurrent neural network (RNN) where connections between nodes form a directed graph along a sequence. A feedforward neural network is a neural network in which the output of each layer is the input of a subsequent layer in the neural network rather than having a recursive loop at each layer.

Another example of a DNN is a convolutional neural network (CNN). A CNN is a class of deep, feed-forward artificial neural networks. A CNN may comprise of an input layer and an output layer, as well as multiple hidden layers. The hidden layers of a CNN typically consist of convolutional layers, pooling layers, fully connected layers, and normalization layers.

The NN 1300 comprises an input layer 1310, and three or more layers 1320 and 1330 through 1340. The input layer 1310 may comprise input data including training documents/data 1305 to train the model(s) 1014, 1016, and 1017 in control management logic circuitry 1012 to perform functionality discussed herein. The input layer 1310 may provide the data in the form of tensor data to the layer 1320. The tensor data may include a vector, matrix, or the like with values associated with each input feature of the NN 1300.

In many embodiments, the input layer 1310 is not modified by backpropagation. The layer 1320 may compute an output and pass the output to the layer 1330. Layer 1330 may determine an output based on the input from layer 1320 and pass the output to the next layer and so on until the layer 1340 receives the output of the second to last layer in the NN 1300. Depending on the methodology of the NN 1300, each layer may include input functions, activation functions, and/or other functions as well as weights and biases assigned to each of the input features. The weights and biases may be randomly selected or defined for the initial state of a new model and may be adjusted through training via backwards propagation (also referred to as backpropagation or backprop). When retraining a model with, e.g., user feedback obtained after an initial training of the model, the weights and biases may have values related to the previous training and may be adjusted through retraining via backwards propagation.

The layer 1340 may generate an output, such as a probability or classification, and pass the output to an objective function logic circuitry 1350. The objective function logic circuitry 1350 may determine errors in the output from the layer 1340 based on an objective function such as a comparison of the predicted results against the expected results from the training documents/data 1305. For instance, the expected results may be paired with the input in the training data supplied for the NN 1300 for supervised training. In one embodiment, the model may represent a machine learning search engine such as search model(s) 1220 in FIG. 1C and the expected results may include answers previously generated for queries associated with previous regulatory assessments.

During the training mode, the objective function logic circuitry 1350 may output errors to backpropagation logic circuitry 1355 to backpropagate the errors through the NN 1300. For instance, the objective function logic circuitry 1350 may output the errors in the form of a gradient of the objective function with respect to the input features of the NN 1300.

The backpropagation logic circuitry 1355 may propagate the gradient of the objective function from the top-most layer, layer 1340, to the bottom-most layer, layer 1320 using the chain rule. The chain rule is a formula for computing the derivative of the composition of two or more functions. That is, if f and g are functions, then the chain rule expresses the derivative of their composition f·g (the function which maps x to f(g(x))) in terms of the derivatives of f and g. After the objective function logic circuitry 1350 computes the errors, backpropagation logic circuitry 1355 backpropagates the errors. The backpropagation is illustrated with the dashed arrows.

When operating in inference mode, the models 1014, 1016, and 1017 of the control management logic circuitry, such as the control management logic circuitry 1012 shown in FIG. 1A, may receive feedback related to which answers are selected by the user and, in some embodiments, the feedback may identify a ranking of the answers presented to the user. If the feedback is negative, the backpropagation may attribute an error to the replacement. If the feedback is positive, the backpropagation may reinforce or bias selection of the replacement within the layers of the NN 1300.

FIG. 1E illustrates an embodiment of a graphical user interface 1460 of a dashboard to organize and present collected data as well as AI derived predictions related to risk involved with business activities for display on a user device such as the user device 1026 shown in FIG. 1A. The dashboard may provide a situational awareness of the control management logic circuitry such as the control management logic circuitry 1012 shown in FIG. 1A. The dashboard provides an overview of the current status of the system as well as access via the GUI 1460 to each part of the functionality offered by the control management logic circuitry.

The dashboard may be configurable via preferences of a user and/or group of users and may present information such as recent activities by the process model(s), control testing model(s), and self-healing model(s) of the control management logic circuitry such as the process model(s) 1014, control testing model(s) 1016, and self-healing model(s) 1018 of the control management logic circuitry 1012 shown in FIG. 1A. Each element in the dashboard may incorporate drill down capabilities. In other words, the dashboard elements may provide a portion of underlying data and/or a representation or summary of the underlying data and a user may interact with an element of the dashboard on the graphical display of the element to access the underlying data used to create the graphical display of the element.

The dashboard also includes a search and filtering element 1462 to perform searches of the data for the control management logic circuitry such as all the data in the data servers 1050 shown in FIG. 1A. A user may also choose to search data related to a specific element on the dashboard such as the elements 1462-1484. For instance, a user may generally search for data related to all the elements in the dashboard by providing a natural language search or providing keywords related to the data that the user seeks.

Alternatively, the user may designate an element such as regulatory obligations 1468 and search data related to the regulatory obligations 1468. For example, the user may want to search for regulatory obligations in the Asia-Pacific (APAC) region and may type “APAC” in the search box of the search and filter element 1462, The user may also want to filter the results and may add to the search box the country “Hong Kong”, a project identifier (ID), a regulation authority such as “Hong Kong Monetary Authority”, a project name, a regulatory question ID, a regulatory answer ID, a category such as “Anomalous activity detection”, and/or the like.

The control objective element 1462 displays the current control objective for the dashboard and lets the user select a control objective from a set of control objectives available for the dashboard. The control objective may include a Control Objectives for Information and Related Technology (COBIT) that defines a set of generic processes for the management of IT. The framework defines each process together with process inputs and outputs, key process-activities, process objectives, performance measures and an elementary maturity model. The control objectives may include, e.g., a complete set of high-level requirements to be considered by management for effective control of each information technology (IT) process.

The non-regulatory requirements element 1464 may include standards that are not statutory or regulatory but are standards that the control management logic circuitry may ingest to identify requirements and create controls. For instance, the non-regulatory requirements element may include COBIT and National Institute of Standards and Technology (NIST) standards. In some embodiments, the non-regulatory requirements element 1464 may display messages on the dashboard such as text of a requirement for the user to verify and selection of the element may allow the user to browse the standards, text ingested standards, and the like.

The Standards, Policy, and Procedures element 1466 may include standards, policies, and procedures that the control management logic circuitry may ingest to identify requirements and create controls. For instance, the standards, policies, and procedures may include regional standards, national standards, business standards, company-wide policies, local policies, operational procedures, and the like. In some embodiments, the Standards, Policy, and Procedures element 1466 may display messages on the dashboard such as text of a requirement for the user to verify and selection of the element may allow the user to browse the standards, policies, and procedures; text ingested from the standards, policies, and procedures, and the like.

The Regulatory Obligations element 1468 may include text of requirements derived, classified, or predicted from regulatory texts such as regional regulations and statutes, industry related regulations and statutes, and the like. The requirements may be associated with multiple tags to identify the regulatory authority, country, region, category, project IDs, project names, regulatory question IDs, regulatory answer IDs, and/or the like. In some embodiments, the Regulatory Obligations element 1468 may display messages on the dashboard such as text of a requirement for the user to verify, predicted requirements, and gaps in the requirements. Selection of the Regulatory Obligations element 1468 may allow the user to browse the regulations, statutes, text ingested from regulations and statues, mapped and unmapped requirements as well as relationships with controls and other data types, and the like. For instance, the user may browse corresponding documents 1054, searchable documents 1056, mapped requirements 1060, unmapped requirements 1062, other data types 1065, and/or the like as shown in the database 1050 in FIG. 1A.

The controls element 1470 may include controls in the form of text, activities descriptions, and/or coding to describe functionality implemented to enforce requirements. In some embodiments, the controls may include one or more tags to identify relationships between the controls and the requirements as well as the other data types associated with the intersection of the controls and the requirements. The controls element 1470 may display recently added controls, control gaps, and/or predicted controls.

The Application and Data Risk element 1472 may display, e.g., a graphical representation of risk related to the control objective identified in the control objective element 1462. For instance, the Application and Data Risk element 1472 may display risk values associated with application software packages and various data associated with the application software packages in relation to regulatory obligations. In one embodiment, the Application and Data Risk element 1472 may display risk values associated accounting software packages and accounting data associated with investment accounts such as risk values related to authorizations to access the accounting software packages and accounting data associated with investment accounts.

The issues and findings element 1474 may include, for instance, detection of anomalies in activities, logs, audit reports, or in groups thereof and information about the activities, logs, audit reports. For instance, the Activities may generate intended or expected data as well as unintended or unexpected data. In some embodiments, the issues and findings element 1474 may display information indicative of the most recent issues and findings related to unintended or unexpected data generated by activities as well as identification of the activities that generated the unintended or unexpected data.

The remediation activities element 1476 may display a graphical representation and/or list of data or tags to identify current and/or historical remediation activities. The remediation activities may include uncorrelated (unmapped) requirements, predicted requirements, and/or control gaps, and risk evaluations associated thereto. In some embodiments, the display may default to the most recent remediation activities related to the control objective selected in the control objective element 1462.

The diagnostic insights element 1478 may display insights derived from analysis and diagnosis of data related to the activity or event points of business activities at the intersection of requirements and controls. The self-healing model(s) may include one or more machine learning models trained to predict risk based on one or more time frame of historical data involving risk assessments and/or one or more models trained to diagnose business activities flagged via the risk prediction models. In some embodiments, the risk prediction models may include models trained generally to predict risk from business activities at activity or event points and/or may include models trained to predict risk at specific activity or event points in business activities based on historical data related to risk assessments of the activities. For instance, risk prediction models may be trained to identify patterns of business activities that deviate from normal patterns of business activities at a particular intersection of requirements and controls. In further embodiments, the risk prediction models may include models trained with historical data identifying risks that rise above accepted risk thresholds and may classify or determine a probability that a pattern of business activities at the point will exceed one or more risk thresholds. In several embodiments, the risk prediction models may continue to learn via feedback in a supervised learning manner.

The diagnostic models may advantageously collect the data occurring at the activity or event points to organize and provide diagnostic insights. For instance, risk prediction models may identify one or more business activities at an intersection of the requirements and controls and one or more diagnostic models that are trained with historical data about patterns of risks associated with business activities and/or patterns of business activities to identify or generate diagnostic insights related to the business activities. For example, the diagnosis models may include prediction models and/or classification models to monitor the business activities over time and to predict a probability of or classify a trend of a business activity as having a risk value higher than one or more risk thresholds in the future. In several embodiments, the diagnosis models may continue to learn via feedback in a supervised learning manner.

The assessment Q&A response element 1480 may generate answers based on questions in a regulatory assessment and display one or more generated answers to a user for verification. The assessment Q&A response element 1480 may generate answers via machine learning models trained to generate or predict answers to the regulatory assessment questions. Such answer models may be trained based on questions and answers in prior regulatory assessments by one or more different groups of users and may generate answers to questions in a current regulatory assessment with consideration of the group of users associated with the user that requests generation of the answers to the questions. In some embodiments, the assessment Q&A response element 1480 may comprise a bulk extract function to generate a complete response to a regulatory assessment or a complete response from a user or group of users to regulatory assessment questions associated with the user or group of users.

The predicted risk and gaps element 1482 may include a graphical display (optionally with drill down capabilities) of the predicted risks, requirement gaps, and control gaps generated by the process models, control testing models, and the self-healing models such as the process model(s) 1014, control testing model(s) 1016, and the self-healing model(s) 1018 shown in FIG. 1A. In some embodiments, the predicted risk and gaps element 1482 may include a graphical display of predicted risks, requirement gaps, and control gaps associated with the control objective selected in the control objective element 1462. The graphical display may include color coding of low, medium, and high risk values and may include a drill down capability to facilitate review of the underlying data used to create the graphical display. For instance, low risk values may be color coded as green, medium risk values may be color coded as yellow, and high risk values may be color coded as red.

The self-healing actions element 1484 may current self-healing actions in the context of the control objective. The self-healing actions may include, e.g., updating requirements from new or updated documents, associating requirements with existing controls, determining gaps in compliance, notifying responsible parties, and performing corrective actions in response to the gaps in compliance. In some embodiments, the gaps in compliance may include new or updated requirements that do not map to existing controls. Some embodiments identify requirements that are not mapped to controls and infer new controls to mitigate risk via one or more self-healing model(s). In some embodiments, the self-healing model(s) may infer a risk or assess a risk based on requirements that do not correlate to existing controls.

FIG. 2 illustrates another embodiment of control management logic circuitry 2012 that operates in a manner similar to the control management logic circuitry 1012 shown in FIG. 1A. The control management logic circuitry 2012 may receive new or updated documents 2005 such as new revisions of regulatory documents, statutory documents, non-regulatory standards, process manuals procedure manuals, policy manuals, industry standards, cybersecurity standards, and/or the like. The process model(s) 1014 may ingest, parse, compare, and identify requirements 2010 from the documents. For instance, the process model(s) 1014 may compare a current document to a prior document to identify the changes in the documents. The process model(s) 1014 may process added text in the documents to determine whether the added text includes new requirements and may compare the new requirements to existing controls to determine mapped and unmapped requirements 2020.

In some embodiments, the process model(s) 1014 may process deleted or retracted portions of the documents and determine existing requirements that are no longer included in the documents. Furthermore, some embodiments may include one or more processing models to compare language of the requirements in the added text to existing requirements identified in the deleted text to determine if the new requirement in the added text is a revision of the prior requirement and to identify the difference in the language of the revision for analysis in the determination about whether the revised requirement should be mapped to an existing control.

The control testing model(s) 1016 may test the controls and, in some embodiments, may test the controls automatically and/or autonomously. In many embodiments, the control testing model(s) 1016 may implement robotics including software bots and, in some embodiments, hardware resources to test controls 2045. For instance, the control testing model(s) 1016 may test a control for updating software versions for applications installed on a user device such as the user device 1026 shown in FIG. 1A. If the testing detects software installations with incorrect version numbers, the control testing model(s) 1016 may output data about the computers having the incorrect software versions, the incorrect software versions installed, the location of the computers, a test report with the results including a summary of the failing computers, and issues related to the control and the incorrect software versions of installed software. In several embodiments, the output data, test report, and the issues may include other data types that are associated with the mapping of the requirements and controls for the control and requirement associated with the software version installations.

The self-healing model(s) 1018 may assess risks and define new controls to mitigate risk 2030 associated with unmapped requirements. If one or more requirements may not have controls to mitigate risk of non-compliance by the organization, the self-healing model(s) 1018 may identify requirements that are not mapped to controls and infer a risk or assess a risk. If the risk falls below a threshold or if the risk, based on training with historical data, is similar to a risk that has not been associated with a control, the self-healing model(s) 1018 may allow the risk to remain unmapped. However, if the risk falls reaches risk threshold or if the risk, based on training with historical data, is similar to a risks that have been associated with a control, the self-healing model(s) 1018 may infer new controls to mitigate risk via one or more self-healing model(s), infer one or more remedial actions to implement the one or more new controls, and perform the one or more remedial actions.

In some embodiments, the self-healing model(s) 1018 may not be able to infer a new control for an uncorrelated (unmapped) new requirement. In such situations, the control management logic circuitry may optionally cause a notification to be transmitted to a user to inform the user of the self-healing model(s) 1018 inability to infer a new control for one or more new uncorrelated requirements. In some embodiment, the self-healing model(s) 1018 may receive via a manual input by a user of the user device 1026, a new control to correlate with the one or more new uncorrelated requirements. In many embodiments, the self-healing model(s) 1018 may receive the new control as part of a supervised learning function and backpropagate the new control through the self-healing model(s) 1018 to train the self-healing model(s) 1018 how to infer such new controls for the one or more new uncorrelated requirements.

The control management logic circuitry 2012 may also include logic to generate a report for a GUI 2050 and may communicate the report to a user via the GUI 2055 to a GUI such as the GUI 1460 shown in FIG. 1A. The report may include unmapped requirements, issues discovered during testing of the controls, predicted risks associated with unmapped (uncorrelated) requirements or control gaps, new controls inferred for unmapped requirements, and/or the like.

The user query and feedback input 2007 may include user queries from the GUI as well as feedback for the inference of new controls, answers predicted based on the questions, risk assessments for unmapped controls, and/or the like.

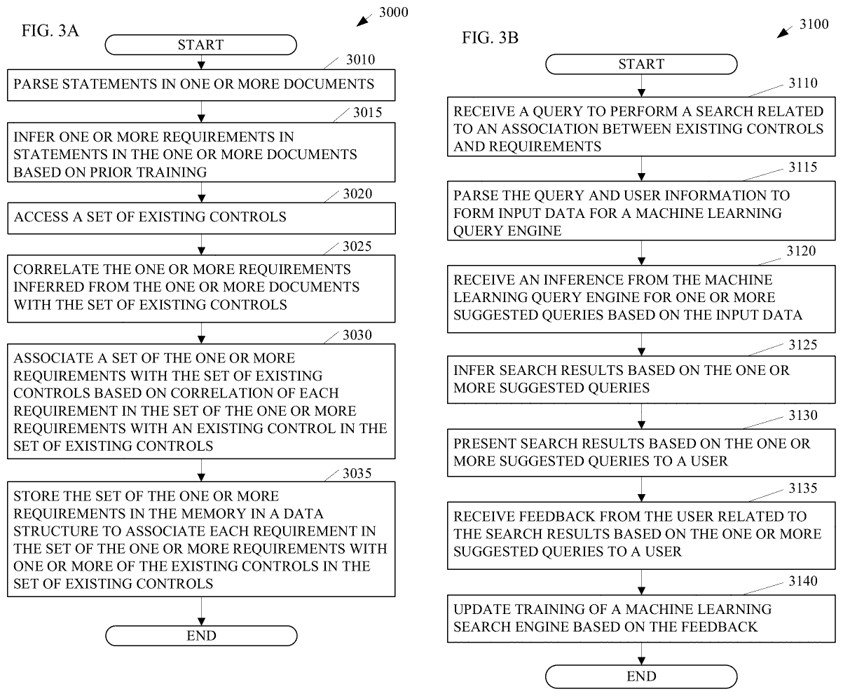

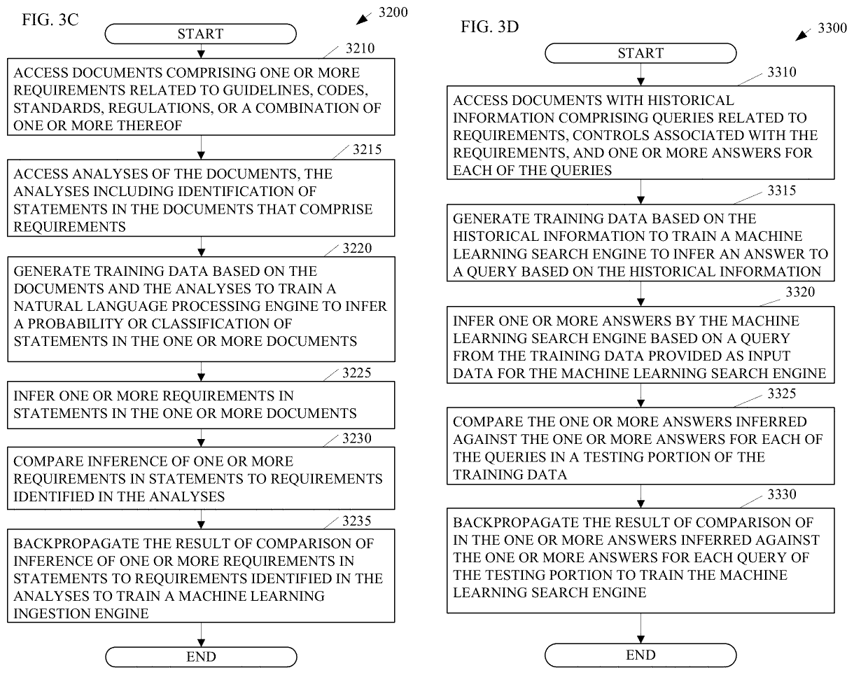

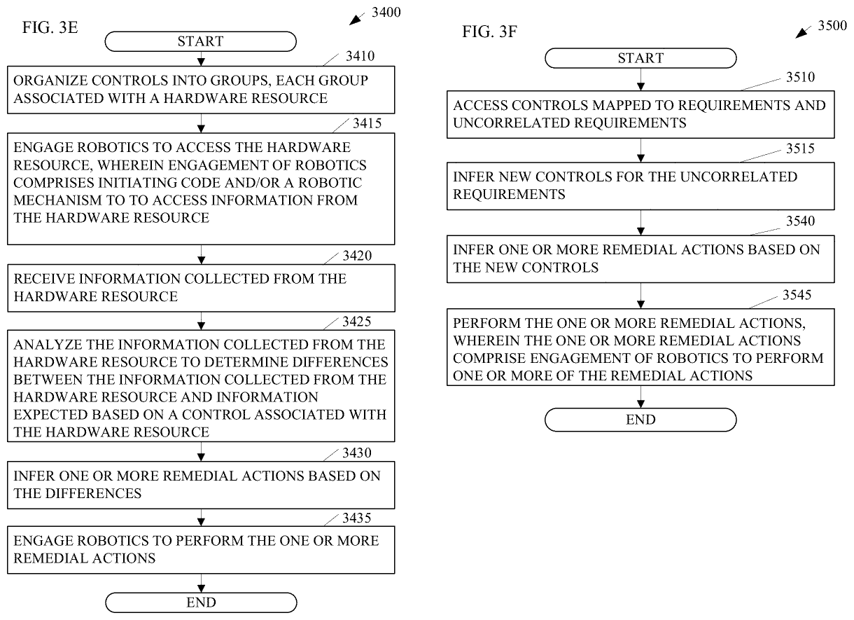

FIG. 3A illustrates an embodiment of a flowchart 3000 for a processing model to process documents such as the processing model(s) 1014 shown in FIG. 1A. The flowchart 3000 begins with parsing statements in one or more documents (element 3010). The processing model may identify and parse portions of the documents that may include requirements and infer one or more requirements in statements in the one or more documents based on prior training (element 3015).

After inferring one or more requirements, the processing model may access a set of existing controls (element 3020) and correlate the one or more requirements inferred from the one or more documents with the set of existing controls (element 3025). In some embodiments, the control management logic circuitry may display the correlations in a dashboard and notify a user to confirm the inferred requirements.

After correlating the one or more requirements, the processing model may associate a set of the one or more requirements with the set of existing controls based on correlation of each requirement in the set of the one or more requirements with an existing control in the set of existing controls (element 3030). The processing model may also store the set of the one or more requirements in the memory in a data structure to associate each requirement in the set of the one or more requirements with one or more of the existing controls in the set of existing controls (element 3035). In further embodiments, the processing model may also relate other data types with the mapping or correlation of the requirements with the controls. The other data types may include data captured by the processing model, a control test model, and/or a self-healing model such as issues, events, test results, outputs, and questions and answers for, e.g., regulatory assessments.

Some embodiments facilitate user input to manually add a new control to associate with one or more requirements. In some of these embodiments, the processing model may facilitate user input by prompting a user to manually input a new control when the processing model is unable to match a requirement to an existing control and/or a self-healing model is unable to infer a new control. In some of these embodiments, the control management logic circuitry, such as the control management logic circuitry 1012 in FIGS. 1A-1B, may notify a user to manually input a new control when the processing model is unable to match a new requirement to an existing control and the self-healing model is unable to infer a control for the unmapped requirement. The user may manually enter the new control directly into the controls such as the controls 1064 shown in FIGS. 1A-1B. Alternatively, the user, via a user device such as the user device 1026 in FIG. 1A, may train the self-healing model with a supervised learning functionality, to infer the new control by backpropagating the new control through the self-healing model in response to an inability or failture to infer a new control for the new requirement.

FIG. 3B illustrates an embodiment of a flowchart 3100 for a processing model to search documents to answer queries such as the processing model(s) 1014 shown in FIG. 1C. The flowchart 3100 begins with receiving a query to perform a search related to an association between existing controls and requirements (element 3110). In response, the processing model may parse the query and user information to form input data for a machine learning query engine (element 3115).

After providing the input to the machine learning query engine, the processing model may receive an inference from the machine learning query engine for one or more suggested queries based on the input data (element 3120) and infer search results based on the one or more suggested queries (element 3125).

After inferring the search results, the processing model may present search results based on the one or more suggested queries to a user (element 3130). In many embodiments, the control management logic circuitry may present the search results to the user via a GUI such as the GUI 1460 shown in FIG. 1E.

The processing model may receive feedback from the user related to the search results based on the one or more suggested queries to a user (element 3135) via the GUI and may update training of a machine learning search engine based on the feedback (element 3140).

FIG. 3C illustrates an embodiment of a flowchart 3200 for training a processing model to identify obligations such as the NN 1300 shown in FIG. 1A. The flowchart 3200 begins with accessing documents comprising one or more requirements related to guidelines, codes, standards, regulations, or a combination of one or more thereof (element 3210) and accessing analyses of the documents, the analyses including identification of statements in the documents that comprise requirements (element 3215).

Based on the documents and analyses, the embodiment may generate training data based on the documents and the analyses to train a natural language processing engine to infer a probability or classification of statements in the one or more documents (element 3220). The training data can be split into a data set for training the model with supervised learning and a data set for testing the model to verify whether the model is trained sufficiently.

With the training data, the embodiment may infer one or more requirements in statements in the one or more documents (element 3225) and compare inference of one or more requirements in statements to requirements identified in the analyses (element 3230). Some embodiments may then backpropagate the result of comparison of inference of one or more requirements in statements to requirements identified in the analyses to train a machine learning ingestion engine (element 3235).

After training the model, the model operation can be verified by feeding the data set for testing the model. If the model produces acceptable and expected results with the data set for testing, then the model is ready for deployment. In other embodiments, the comparison element 3230 may comprise presentation of the inference to a user and receipt of the result of the comparison from the user via, e.g., a GUI such as the GUI 1460 show in FIG. 1E.

FIG. 3D illustrates an embodiment of a flowchart 3300 for training a processing model to determine search results responsive to a query such as the processing model(s) 1014 shown in FIG. 1A. The flowchart 3300 begins with accessing documents with historical information comprising queries related to requirements, controls associated with the requirements, and one or more answers for each of the queries (element 3310) and generate training data based on the historical information to train a machine learning search engine to infer an answer to a query based on the historical information (element 3315).

The embodiment may then divide the training data into a training data set and a testing data set. With the training data set, the embodiment may infer one or more answers by the machine learning search engine based on a query from the training data provided as input data for the machine learning search engine (element 3320) and compare the one or more answers inferred against the one or more answers for each of the queries in a testing portion of the training data (element 3325). In other embodiments, the comparison element 3230 may comprise presentation of the inference to a user and receipt of the result of the comparison from the user via, e.g., a GUI such as the GUI 1460 show in FIG. 1E.

After comparison of the inferred answers, the embodiment may backpropagate the result of comparison of in the one or more answers inferred against the one or more answers for each query of the testing portion to train the machine learning search engine (element 3330). Once the model is trained, the model operation can be verified by feeding the data set for testing the model. If the model produces acceptable and expected results with the testing data set, the model may be ready for deployment. In other embodiments, the comparison element 3325 may comprise presentation of the inference to a user and receipt of the result of the comparison from the user via, e.g., a GUI such as the GUI 1460 show in FIG. 1E.

FIG. 3E illustrates an embodiment of a flowchart 3400 for a control testing model. such as the control testing model(s) 1016 shown in FIG. 1A. The flowchart 3400 begins with organizing controls into groups, each group associated with a hardware resource (element 3410) and engage robotics to access the hardware resource, wherein engagement of robotics comprises initiating code and/or a robotic mechanism to physically manipulate and/or otherwise access information from the hardware resource (element 3415). For instance, the hardware resource may comprise a remote server with logs, audit reports, preferences, and/or the like.

After accessing the hardware resource, the control testing model may receive information collected from the hardware resource (element 3420). The control testing model may analyze the information collected from the hardware resource to determine differences between the information collected from the hardware resource and information expected based on a control associated with the hardware resource (element 3425).

Based on the differences, the control testing model may infer one or more remedial actions (element 3430) and engage robotics to perform the one or more remedial actions (element 3435). For instance, the robotics may include software bots to update an installation of a software package on a hardware resource so the software package conforms with a requirement associated with the control.

FIG. 3F illustrates an embodiment of a flowchart 3500 for a self-healing, control management model such as the self-healing model(s) 1018 shown in FIG. 1A. The flowchart 3500 begins with accessing controls mapped to requirements and uncorrelated (unmapped) requirements (element 3510). The healing, control management model may infer new controls for the uncorrelated requirements (element 3515) and infer one or more remedial actions based on the new controls (element 3540). Some embodiments may also include notifying a user via, e.g., a GUI such as the GUI 1460 shown in FIG. 1E, and receiving a confirmation for one or more of the remedial actions or feedback to update the models to improve the inference.

After inferring the new controls and remedial actions, the self-healing, control management model may perform the one or more remedial actions, wherein the one or more remedial actions comprise engagement of robotics to perform one or more of the remedial actions (element 3545).

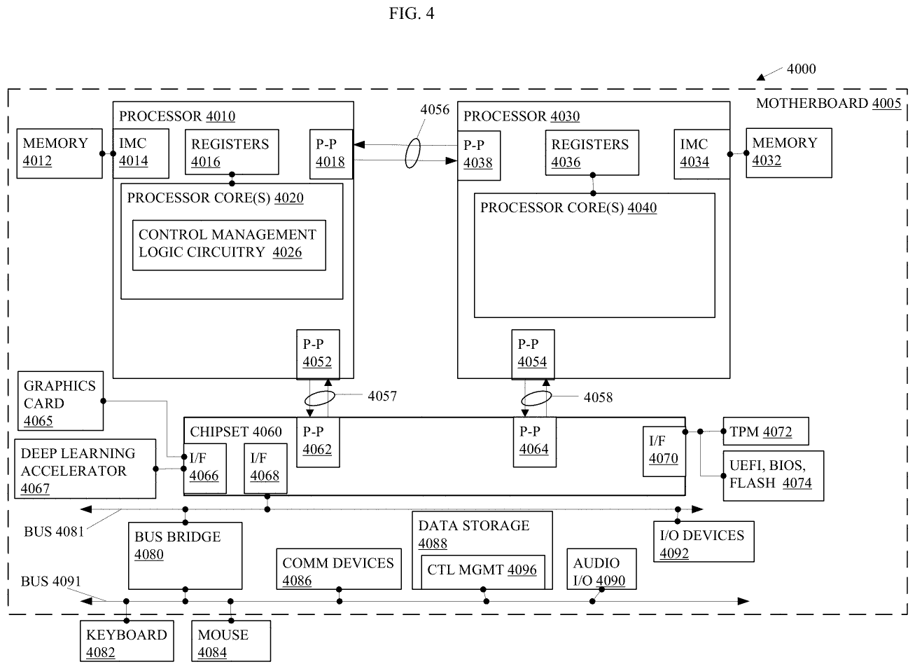

FIG. 4 illustrates an embodiment of a system 4000 such as a server of the server(s) 1010 shown in FIG. 1A or the apparatus 1100 shown in FIG. 1B. The system 4000 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the system 4000 may have a single processor with one core or more than one processor. Note that the term “processor” refers to a processor with a single core or a processor package with multiple processor cores.

As shown in FIG. 4, system 4000 comprises a motherboard 4005 for mounting platform components. The motherboard 4005 is a point-to-point interconnect platform that includes a first processor 4010 and a second processor 4030 coupled via a point-to-point interconnect 4056 such as an Ultra Path Interconnect (UPI). In other embodiments, the system 4000 may be of another bus architecture, such as a multi-drop bus. Furthermore, each of processors 4010 and 4030 may be processor packages with multiple processor cores including processor core(s) 4020 and 4040, respectively. While the system 4000 is an example of a two-socket (2S) platform, other embodiments may include more than two sockets or one socket. For example, some embodiments may include a four-socket (4S) platform or an eight-socket (8S) platform. Each socket is a mount for a processor and may have a socket identifier. Note that the term platform refers to the motherboard with certain components mounted such as the processors 4010 and the chipset 4060. Some platforms may include additional components and some platforms may only include sockets to mount the processors and/or the chipset.

The first processor 4010 includes an integrated memory controller (IMC) 4014 and point-to-point (P-P) interconnects 4018 and 4052. Similarly, the second processor 4030 includes an IMC 4034 and P-P interconnects 4038 and 4054. The IMC's 4014 and 4034 couple the processors 4010 and 4030, respectively, to respective memories, a memory 4012 and a memory 4032. The memories 4012 and 4032 may be portions of the main memory (e.g., a dynamic random-access memory (DRAM)) for the platform such as double data rate type 3 (DDR3) or type 4 (DDR4) synchronous DRAM (SDRAM). In the present embodiment, the memories 4012 and 4032 locally attach to the respective processors 4010 and 4030. In other embodiments, the main memory may couple with the processors via a bus and shared memory hub.

The processors 4010 and 4030 comprise caches coupled with each of the processor core(s) 4020 and 4040, respectively. In the present embodiment, the processor core(s) 4020 of the processor 4010 include a control management logic circuitry 4026 such as the control management logic circuitry 1012 shown in FIGS. 1A and 1B. The control management logic circuitry 4026 may represent circuitry configured to process documents such as regulatory documents, operating procedures, industry standards, cybersecurity standards, and/or the like, to identify obligations and, particularly new or revised obligations within the processor core(s) 4020. The control management logic circuitry 4026 may represent a combination of the circuitry within a processor and a medium to store all or part of the functionality of the control management logic circuitry 4026 in memory such as cache, the memory 4012, buffers, registers, and/or the like. In several embodiments, the functionality of the control management logic circuitry 4026 resides in whole or in part as code in a memory such as the control management logic circuitry 4096 in the data storage unit 4088 attached to the processor 4010 via a chipset 4060 such as the control management logic circuitry 1012 shown in FIGS. 1A-1B. The functionality of the control management logic circuitry 4026 may also reside in whole or in part in memory such as the memory 4012 and/or a cache of the processor. Furthermore, the functionality of the control management logic circuitry 4026 may also reside in whole or in part as circuitry within the processor 4010 and may perform operations, e.g., within registers or buffers such as the registers 4016 within the processor 4010, registers 4036 within the processor 4030, or within an instruction pipeline of the processor 4010 or the processor 4030.

In other embodiments, more than one of the processor 4010 and 4030 may comprise functionality of the control management logic circuitry 4026 such as the processor 4030 and/or the processor within the deep learning accelerator 4067 coupled with the chipset 4060 via an interface (I/F) 4066. The I/F 4066 may be, for example, a Peripheral Component Interconnect-enhanced (PCI-e).

The first processor 4010 couples to a chipset 4060 via P-P interconnects 4052 and 4062 and the second processor 4030 couples to a chipset 4060 via P-P interconnects 4054 and 4064. Direct Media Interfaces (DMIs) 4057 and 4058 may couple the P-P interconnects 4052 and 4062 and the P-P interconnects 4054 and 4064, respectively. The DMI may be a high-speed interconnect that facilitates, e.g., eight Giga Transfers per second (GT/s) such as DMI 3.0. In other embodiments, the processors 4010 and 4030 may interconnect via a bus.

The chipset 4060 may comprise a controller hub such as a platform controller hub (PCH). The chipset 4060 may include a system clock to perform clocking functions and include interfaces for an I/O bus such as a universal serial bus (USB), peripheral component interconnects (PCIs), serial peripheral interconnects (SPIs), integrated interconnects (I2Cs), and the like, to facilitate connection of peripheral devices on the platform. In other embodiments, the chipset 4060 may comprise more than one controller hub such as a chipset with a memory controller hub, a graphics controller hub, and an input/output (I/O) controller hub.

In the present embodiment, the chipset 4060 couples with a trusted platform module (TPM) 4072 and the unified extensible firmware interface (UEFI), BIOS, Flash component 4074 via an interface (I/F) 4070. The TPM 4072 is a dedicated microcontroller designed to secure hardware by integrating cryptographic keys into devices. The UEFI, BIOS, Flash component 4074 may provide pre-boot code.

Furthermore, chipset 4060 includes an I/F 4066 to couple chipset 4060 with a high-performance graphics engine, graphics card 4065. In other embodiments, the system 4000 may include a flexible display interface (FDI) between the processors 4010 and 4030 and the chipset 4060. The FDI interconnects a graphics processor core in a processor with the chipset 4060.

Various I/O devices 4092 couple to the bus 4081, along with a bus bridge 4080 which couples the bus 4081 to a second bus 4091 and an I/F 4068 that connects the bus 4081 with the chipset 4060. In one embodiment, the second bus 4091 may be a low pin count (LPC) bus. Various devices may couple to the second bus 4091 including, for example, a keyboard 4082, a mouse 4084, communication devices 4086 and a data storage unit 4088 that may store code such as the adjust logic circuitry 4096. Furthermore, an audio I/O 4090 may couple to second bus 4091. Many of the I/O devices 4092, communication devices 4086, and the data storage unit 4088 may reside on the motherboard 4005 while the keyboard 4082 and the mouse 4084 may be add-on peripherals. In other embodiments, some or all the I/O devices 4092, communication devices 4086, and the data storage unit 4088 are add-on peripherals and do not reside on the motherboard 4005.

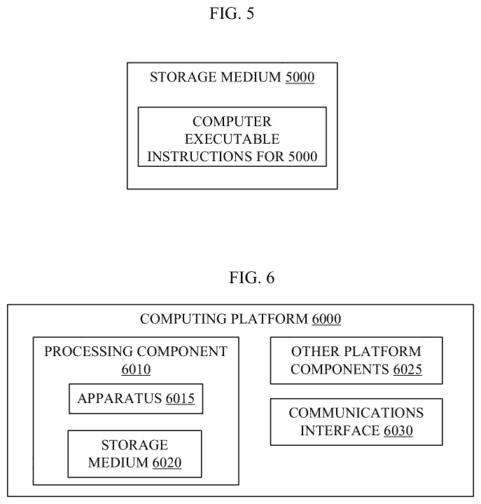

FIG. 5 illustrates an example of a storage medium 5000 to store control management logic circuitry such as the control management logic circuitry 1012 and 4026 as shown in FIGS. 1A-B and 4. Storage medium 5000 may comprise an article of manufacture. In some examples, storage medium 5000 may include any non-transitory computer readable medium or machine readable medium, such as an optical, magnetic or semiconductor storage. Storage medium 5000 may store various types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 6 illustrates an example computing platform 6000 such as the server(s) 1010, apparatus 1100, and the system 4000 shown in FIG. 4. In some examples, as shown in FIG. 6, computing platform 6000 may include a processing component 6010, other platform components or a communications interface 6030. According to some examples, computing platform 6000 may be implemented in a computing device such as a server in a system such as a data center or server farm that supports a manager or controller for managing configurable computing resources as mentioned above. Furthermore, the communications interface 6030 may comprise a wake-up radio (WUR) and may be capable of waking up a main radio of the computing platform 6000.

According to some examples, processing component 6010 may execute processing operations or logic for apparatus 6015 described herein such as the adjust logic circuitry 1015 and 1110 illustrated in FIGS. 1A and 1B, respectively. Processing component 6010 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements, which may reside in the storage medium 6020, may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 6025 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 6030 may include logic and/or features to support a communication interface. For these examples, communications interface 6030 may include one or more communication interfaces that operate according to various communication protocols or standards to communicate over direct or network communication links. Direct communications may occur via use of communication protocols or standards described in one or more industry standards (including progenies and variants) such as those associated with the PCI Express specification. Network communications may occur via use of communication protocols or standards such as those described in one or more Ethernet standards promulgated by the Institute of Electrical and Electronics Engineers (IEEE). For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”). Network communication may also occur according to one or more OpenFlow specifications such as the OpenFlow Hardware Abstraction API Specification. Network communications may also occur according to Infiniband Architecture Specification, Volume 1, Release 1.3, published in March 2015 (“the Infiniband Architecture specification”).

Computing platform 6000 may be part of a computing device that may be, for example, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing platform 6000 described herein, may be included or omitted in various embodiments of computing platform 6000, as suitably desired.

The components and features of computing platform 6000 may be implemented using any combination of discrete circuitry, ASICs, logic gates and/or single chip architectures. Further, the features of computing platform 6000 may be implemented using microcontrollers, programmable logic arrays and/or microprocessors or any combination of the foregoing where suitably appropriate. It is noted that hardware, firmware and/or software elements may be collectively or individually referred to herein as “logic”.

It should be appreciated that the computing platform 6000 shown in the block diagram of FIG. 6 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores”, may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium such as the storage medium 5000 shown in FIG. 5. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

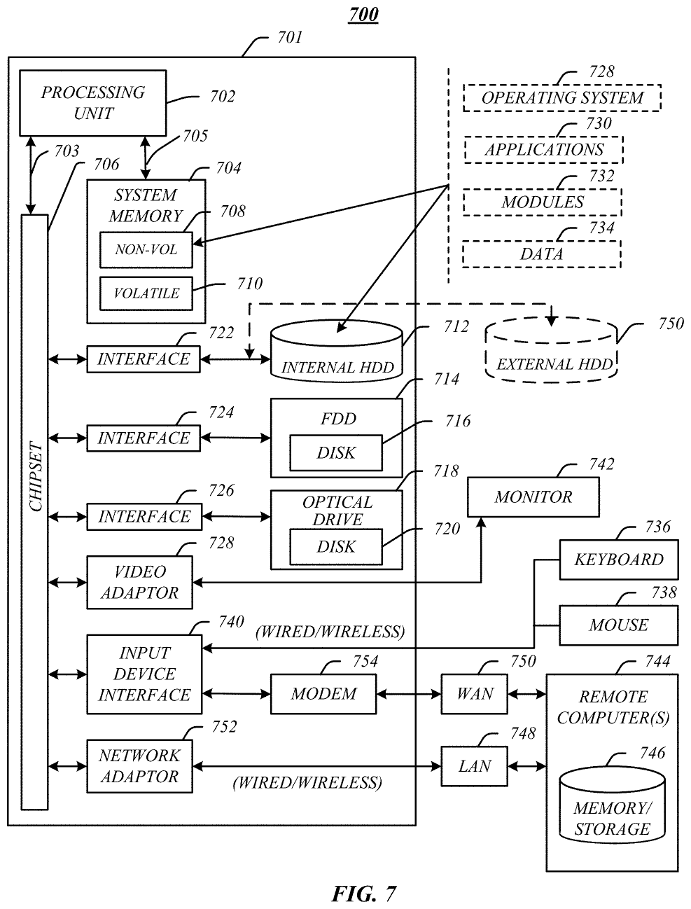

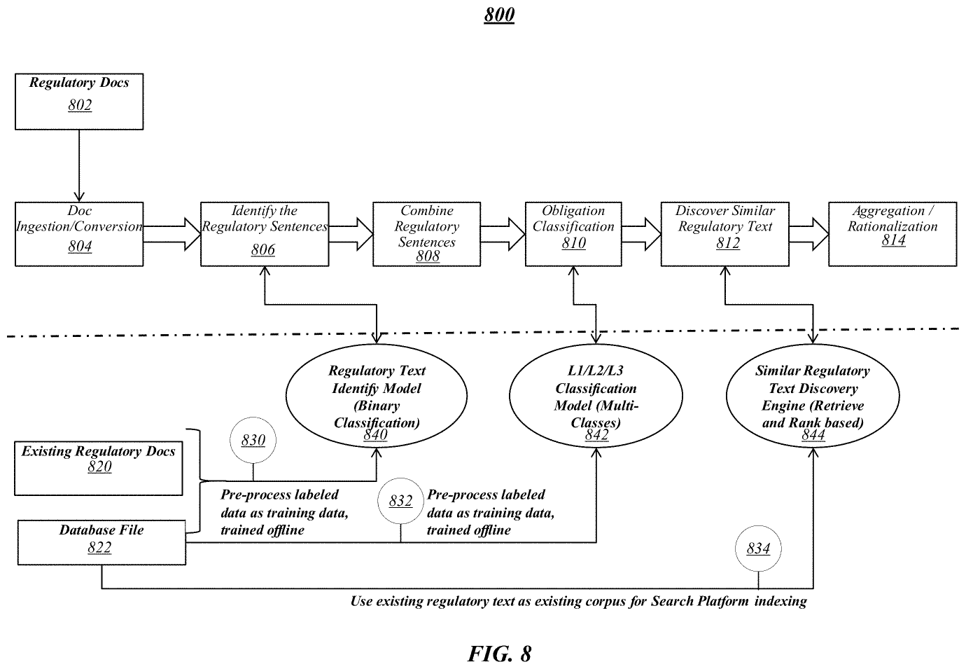

FIG. 7 illustrates an embodiment of an exemplary computing architecture 700 suitable for implementing various embodiments described herein. In one embodiment, the computing architecture 700 may comprise or be implemented as part of an electronic device, such as a computer 701 such as the server(s) 1010, apparatus 1100, system 4000, and computing platform 6000 shown in FIGS. 1A-B, 4, and 6. The embodiments are not limited in this context.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process executing on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 702, a system memory 704 and a chipset 706. The processing unit 702 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core i9™, Core m3™, vPro™, Itanium®, Pentium®, Xeon®, and XScale® processors; and similar processors. Dual microprocessors, multi-core processors, and other multi-processor architectures may also be employed as the processing unit 702.

In some embodiments, the processing unit 702 couples with the chipset 706 via a highspeed serial link 703 and couples with the system memory 704 via a highspeed serial link 705. In other embodiments, the processing unit 702 may couple with the chipset 706 and possibly other processor units via a system bus and may couple with the system memory 704 via the chipset 706. In further embodiments, the processing unit 702 and the chipset may reside in a System-On-Chip (SoC) package.

The chipset 706 provides an interface for system components including, but not limited to, the system memory 704 to the processing unit 702. The chipset 706 may couple with any of several types of bus structure that may further interconnect to a memory bus (with or without a memory controller), a peripheral bus, and a local bus using any of a variety of commercially available bus architectures. Interface adapters 722, 724, 726, 728, 740, 752, etc., may connect to the chipset 706 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture such as the storage medium shown in FIG. 5. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 704 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 704 can include non-volatile memory 708 and/or volatile memory 710. A basic input/output system (BIOS) can be stored in the non-volatile memory 708.

The computing architecture 700 may include various types of computer-readable storage media in the form of one or more lower speed memory units, including an internal (or external) hard disk drive (HDD) 712, a magnetic floppy disk drive (FDD) 714 to read from or write to a removable magnetic disk 716, and an optical disk drive 718 to read from or write to a removable optical disk 720 (e.g., a CD-ROM or DVD). The HDD 712, FDD 714 and optical disk drive 720 can be connected to the system bus 706 by an HDD interface 722, an FDD interface 724 and an optical drive interface 726, respectively. The HDD interface 722 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 708, 712, including an operating system 728, one or more application programs 730, other program modules 732, and program data 734. In one embodiment, the one or more application programs 730, other program modules 732, and program data 734 can include, for example, the various applications and/or components described herein.

A user may enter commands and information into the computer 701 through one or more wire/wireless input devices, for example, a keyboard 736 and a pointing device, such as a mouse 738. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 702 through an input device interface 740 that is coupled to the chipset 706, but can be connected by other interfaces such as a parallel port, IEEE 694 serial port, a game port, a USB port, an IR interface, and so forth.

A monitor 742 or other type of display device is also connected to the chipset 706 via an interface, such as a video adaptor 728. The monitor 742 may be internal or external to the computer 701. In addition to the monitor 742, a computer typically includes other peripheral output devices, such as speakers, printers, and so forth.

The computer 701 may operate in a networked environment using logical connections via wire and/or wireless communications to one or more remote computers, such as a remote computer 744. The remote computer 744 can be a workstation, a server computer, a router, a personal computer, portable computer, microprocessor-based entertainment appliance, a peer device or other common network node, and typically includes many of or all the elements described relative to the computer 701, although, for purposes of brevity, only a memory/storage device 746 is illustrated. The logical connections depicted include wire/wireless connectivity to a local area network (LAN) 748 and/or larger networks, for example, a wide area network (WAN) 750. Such LAN and WAN networking environments are commonplace in offices and companies, and facilitate enterprise-wide computer networks, such as intranets, all which may connect to a global communications network, for example, the Internet.

When used in a LAN networking environment, the computer 701 is connected to the LAN 748 through a wire and/or wireless communication network interface or adaptor 752. The adaptor 752 can facilitate wire and/or wireless communications to the LAN 748, which may also include a wireless access point disposed thereon for communicating with the wireless functionality of the adaptor 752.

When used in a WAN networking environment, the computer 701 can include a modem 754, or is connected to a communications server on the WAN 750, or has other means for establishing communications over the WAN 750, such as by way of the Internet. The modem 754, which can be internal or external and a wire and/or wireless device, connects to the chipset 706 via the input device interface 740. In a networked environment, program modules depicted relative to the computer 701, or portions thereof, can be stored in the remote memory/storage device 746. It will be appreciated that the network connections shown are exemplary and other means of establishing a communications link between the computers can be used.

The computer 701 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

Some aspects may utilize the Internet of Things (IoT), where things (e.g., machines, devices, phones, sensors) can be connected to networks and the data from these things can be collected and processed within the things and/or external to the things. For example, with the IoT, sensors may be deployed in many different devices, and high-value analytics can be applied to identify hidden relationships and drive increased efficiencies. This can apply to both Big Data analytics and real-time (streaming) analytics.

Some systems may use Hadoop®, an open-source framework for storing and analyzing big data in a distributed computing environment. Apache™ Hadoop® is an open-source software framework for distributed computing. For example, some grid systems may be implemented as a multi-node Hadoop® cluster, as understood by a person of skill in the art. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction.

FIG. 8 illustrates an example of an operating environment 800 for a process model such as the processing model(s) 1014 shown in FIG. 1A to process text of one or more types of documents such as regulatory text, operating procedures, industry standards, cybersecurity standards, and/or the like. The operating environment 800 depicted in FIG. 8 may implement text categorization processes according to various embodiments. As shown in FIG. 8, a text corpus 802 may be ingested/converted 804. In various embodiments, text corpus 802 may be a new text corpus that has not been analyzed via text categorization processes. In some embodiments, text corpus 802 may include regulatory documents (for instance, regulatory documents associated with a particular industry of interest). Sentences, or statements, of interest may be identified 806 and combined 808. For example, regulatory sentences in regulatory documents 802 may be determined and combined. Events associated with the sentences may be classified 810. For example, an event may include any action, obligation, result, risk level, and/or the like indicated by the sentence. For example, for a regulatory document, a sentence may define an obligation (for instance, a reporting obligation to a governmental body). The obligations delineated by the regulatory sentences may be classified 810. In various embodiments, similar (or related) regulatory text may be determined 812 and aggregated/rationalized 814.

In some embodiments, text categorization processes may access one or more existing (or historical) text sources (for instance, existing regulatory documents) 820 and/or a database file (for instance, a comma delimited file, a Microsoft® Excel® file, and/or the like that includes previously categorized text (for instance, known regulations). In exemplary embodiments, labeled data of existing regulatory documents 820 may be pre-processed 830, for example, as training data for offline training. For example, an identification model 840 may access the labeled data to implement the identification of sentences of interest 806. In some embodiments, identification model may include a binary classification model. Although binary classification models are used in some examples, embodiments are not so limited, as any type of model, process, and/or the like capable of operating according to some embodiments is contemplated herein.

In various embodiments, pre-processed data of database file 822 may be labeled as training data for offline training 832 and provided to classification model 842. In some embodiments, existing text may be used as an existing corpus for indexing by a search platform 834 and provided to a similar text discovery engine 844. A non-limiting example of a search platform may be or may include Apache Solr™ (by the Apache Software Foundation).

Included herein are one or more logic flows representative of exemplary methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, hardware, or any combination thereof. In software and firmware embodiments, a logic flow may be implemented by computer executable instructions stored on a non-transitory computer readable medium or machine readable medium. Embodiments are not limited in this context.

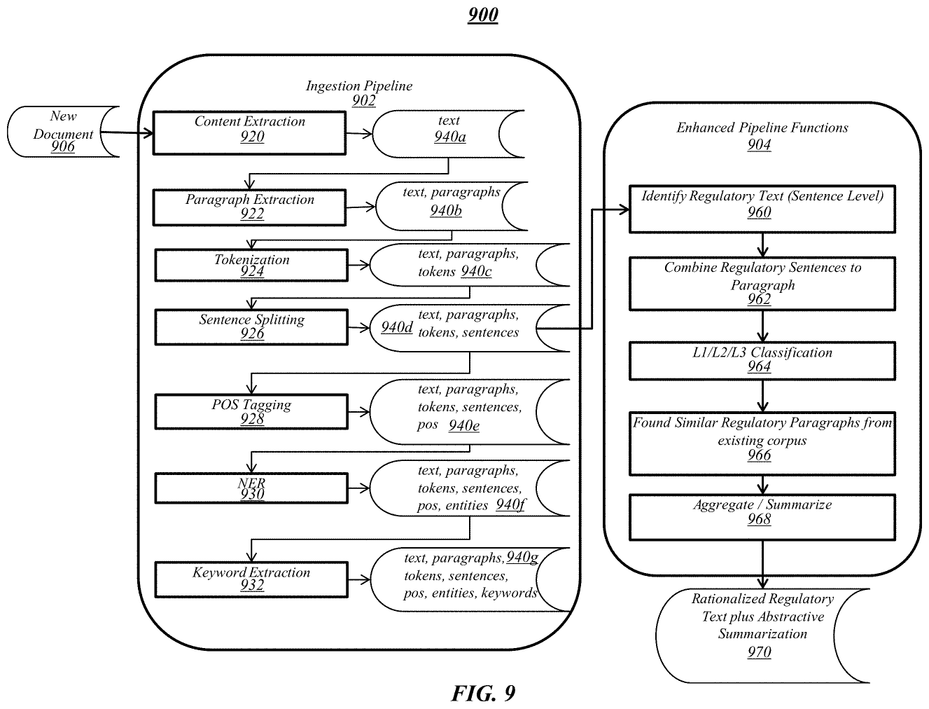

FIG. 9 illustrates an embodiment of a logic flow 900. Logic flow 900 may be representative of operations executed by one or more embodiments described herein, such as processing model(s) 1014 shown in FIGS. 1A-B and 2. In some embodiments, logic flow 900 may be representative of some or all of the operations of a text categorization process. Logic flow 900 may include an ingestion pipeline 902 and enhanced pipeline functions 904.

In general, logic flow 900 may implement a text categorization process operative to identify text of interest (e.g., regulatory text) in documents (e.g., regulatory manuals) via, for example, a neural network (NN), such as a context NN (CNN); combine sentences, or other textual segments of interest, into larger textual segments (for example, using a rule-based process, regulatory sentences in the same paragraph in an original document may be combined into one paragraph in a categorized document); classify obligation text into information technology (IT) taxonomy (for instance, via a textcat model from spaCy (by Explosion AI)); discover similar regulations (for instance, via a search, retrieve, and rank based information retrieval), and consolidate rationalized regulatory obligations (for instance, via a rule-based process including concatenating similar regulation paragraphs).

As shown in FIG. 9, logic flow 900 may access a new document 906 and perform context extraction 920 to generate text 940a. At step 922, logic flow 900 may perform paragraph extraction 922 to generate output 940b, which may be processed via tokenization 924 to generate output 940c. At step 926, logic flow 900 may perform sentence splitting to generate output 940d, which may be processed via point-of-speech (POS) tagging to generate output 940e. Logic flow 900 may perform named entity recognition (NER) 930 to generate output 940f, which may be processed via keyword extraction to generate output 940g.

In various embodiments, output 940d may be processed via enhanced pipeline functions 904. For example, output 940d may be processed via an identify regulatory text (sentence level) step 960, a combine regulatory sentences to paragraph step 962, a multi-level (for instance, L1/L2/L3) classification step 964, a found similar regulatory paragraphs from existing corpus step 966, and/or an aggregate/summarize step 960 to generate a rationalized regulatory text (plus an abstractive summarization) 970.

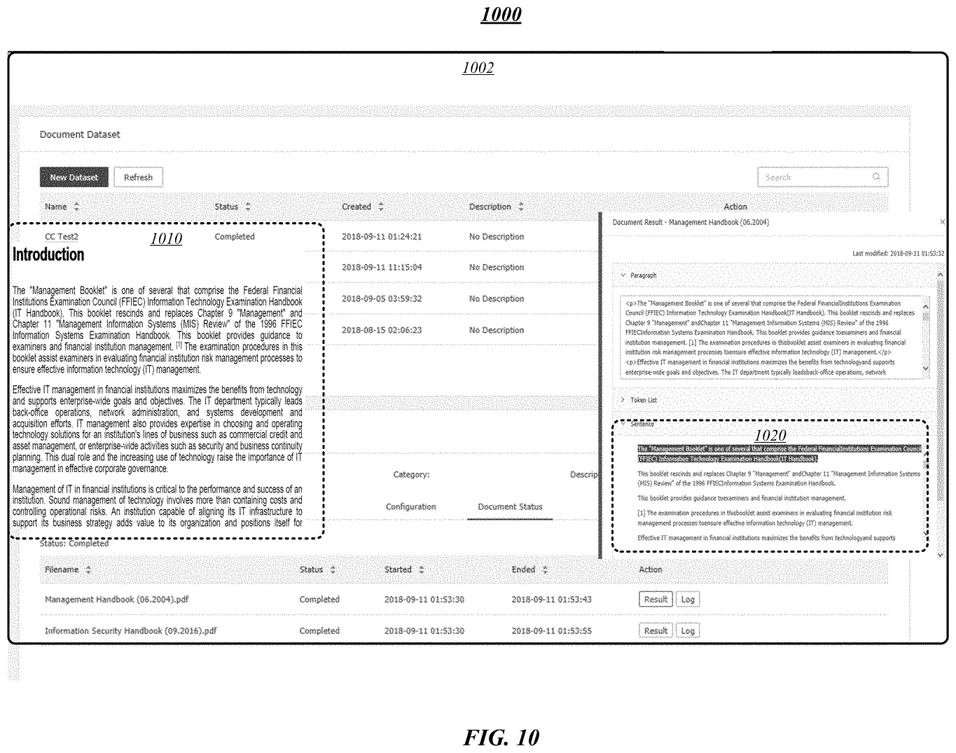

FIG. 10 illustrates an example of an operating environment 10000 that may be representative of various embodiments such as system 1000, apparatus 1100, system 4000, computing platform 6000, and computing platform 700. The operating environment 1000 depicted in FIG. 10 may implement a graphical user interface (GUI) for text categorization processes according to various embodiments. As shown in FIG. 10, a GUI 10002 may present uncategorized text 10010. A document ingestion service according to some embodiments may be used (or re-used) to convert regulatory documents and extract regulatory text 10020, for example, at the sentence level.

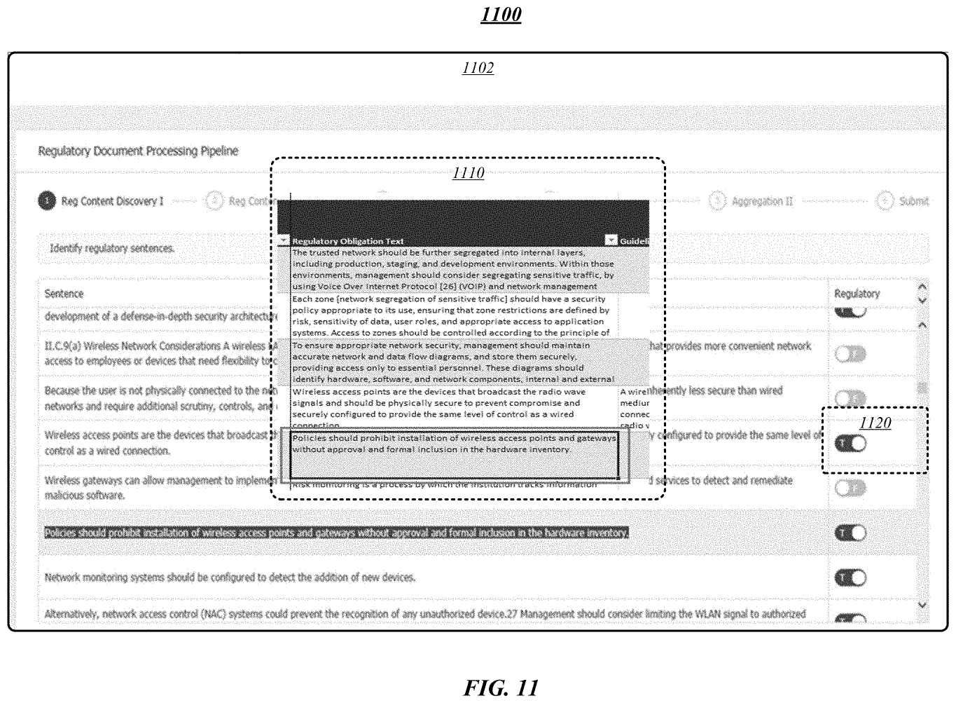

FIG. 11 illustrates an example of an operating environment 11000 that may be representative of various embodiments such as system 1000, apparatus 1100, system 4000, computing platform 6000, and computing platform 700. The operating environment 11000 depicted in FIG. 11 may implement a graphical user interface (GUI) for text categorization processes according to various embodiments, such as a categorized text identification step. As shown in FIG. 11, a GUI 11002 may present regulatory text 11010. In some embodiments, a classification model, such as a binary classification model, may be used to predict if the sentence of text 1110 is regulatory text. In the embodiment shown in FIG. 11, the bounded regulatory text is predicted as “T” (regulatory text). In the corresponding database file, the bounded regulatory text may be included and labelled as regulatory text, indicating a correct prediction. GUI 11002 may include a manual feedback element 11020, for example, that may be toggled, selected, or otherwise virtually actuated to manually confirm or correct the result. In some embodiments, such manual input may be used for future model training.

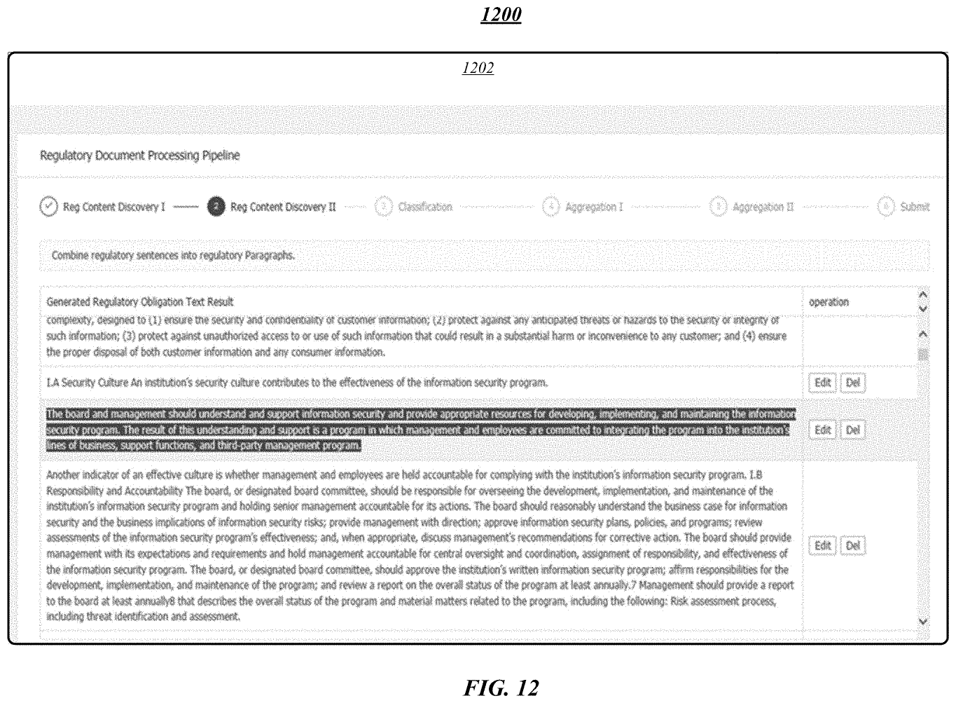

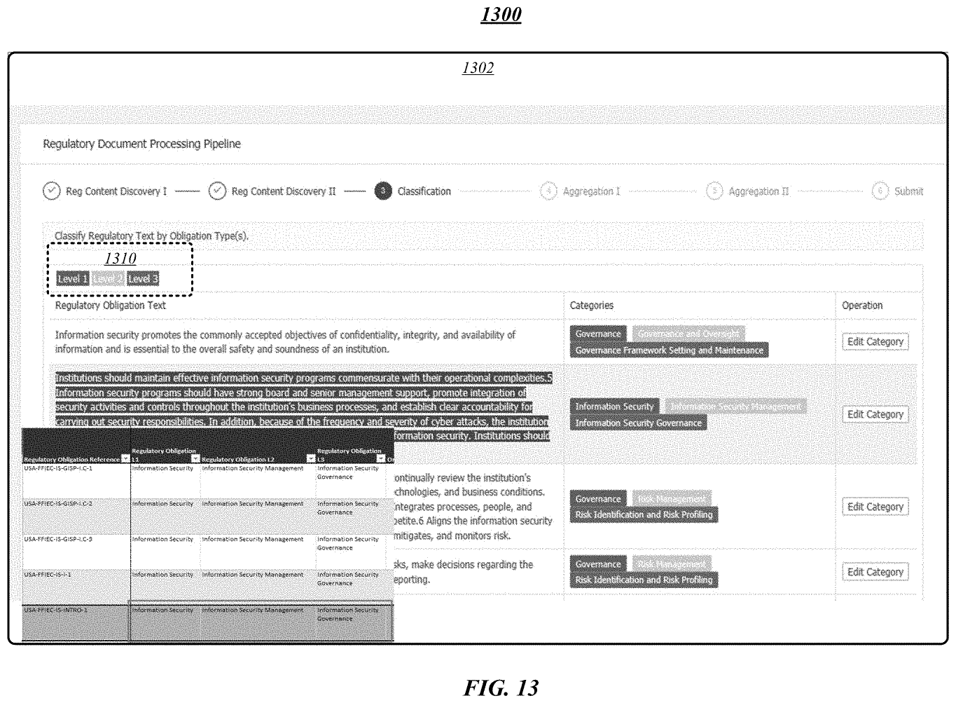

FIG. 12 illustrates an example of an operating environment 12000 that may be representative of various embodiments such as system 1000, apparatus 1100, system 4000, computing platform 6000, and computing platform 700. The operating environment 12000 depicted in FIG. 12 may implement a graphical user interface (GUI) 12002 for text categorization processes according to various embodiments, such as a step operative to combine sentences of interest into paragraphs. FIG. 13 illustrates an example of an operating environment 1300 that may be representative of various embodiments such as system 1000, apparatus 1100, system 4000, computing platform 6000, and computing platform 700. The operating environment 13000 depicted in FIG. 13 may implement a graphical user interface (GUI) 13002 for text categorization processes according to various embodiments, such as a step operative to classify regulatory text by obligation type 13010. Non-limiting examples of obligation type may include levels (for instance, risk levels), governance, IT, information security, compliance, risk identification, risk management, and/or the like.

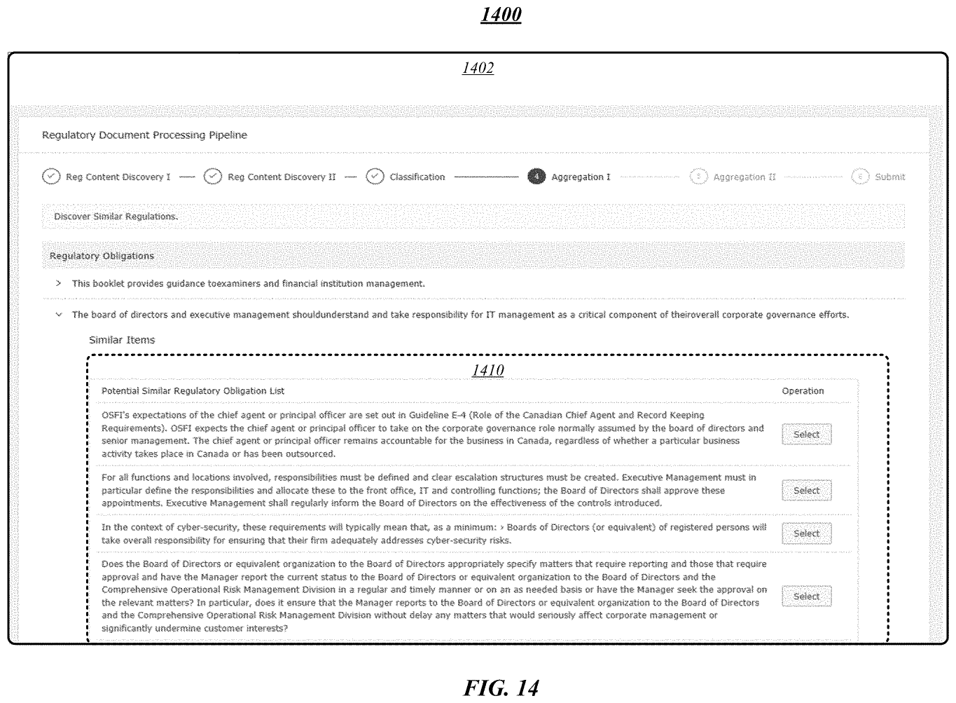

FIG. 14 illustrates an example of an operating environment 1400 that may be representative of various embodiments such as system 1000, apparatus 1100, system 4000, computing platform 6000, and computing platform 700. The operating environment 1400 depicted in FIG. 14 may implement a graphical user interface (GUI) 1402 for text categorization processes according to various embodiments, such as a step operative to discover similar regulations. In some embodiments GUI 1402 may present a list of similar regulations 1410. In various embodiments, text categorization processes may generate list 1410 for new regulatory text. For example, text categorization processes may re-use retrieve and rank services to discover similar regulations in a history corpus. In some embodiments, an operator may review and select similar regulations, for example, for grouping/aggregation.

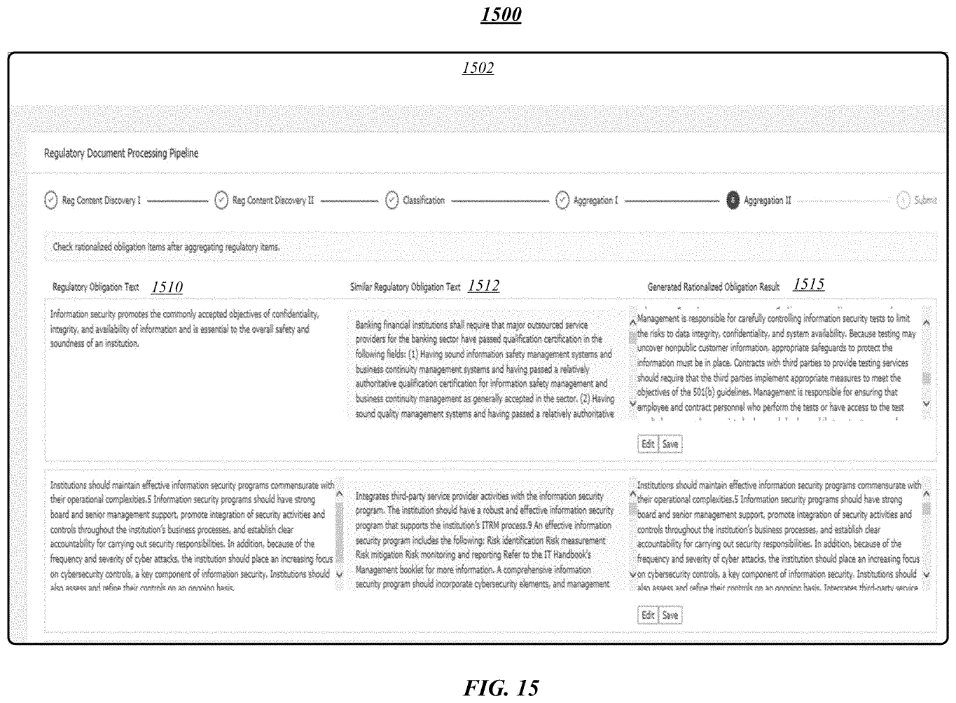

FIG. 15 illustrates an example of an operating environment 1500 that may be representative of various embodiments such as system 1000, apparatus 1100, system 4000, computing platform 6000, and computing platform 700. The operating environment 1500 depicted in FIG. 15 may implement a graphical user interface (GUI) 1502 for text categorization processes according to various embodiments, such as a step operative to perform aggregation and/or rationalization. As shown in FIG. 15, GUI 1502 may present determined regulatory text 1510, determined similar regulatory text 1512, and generated rationalized obligation results 1514, which may be edited and/or saved via GUI 1502.

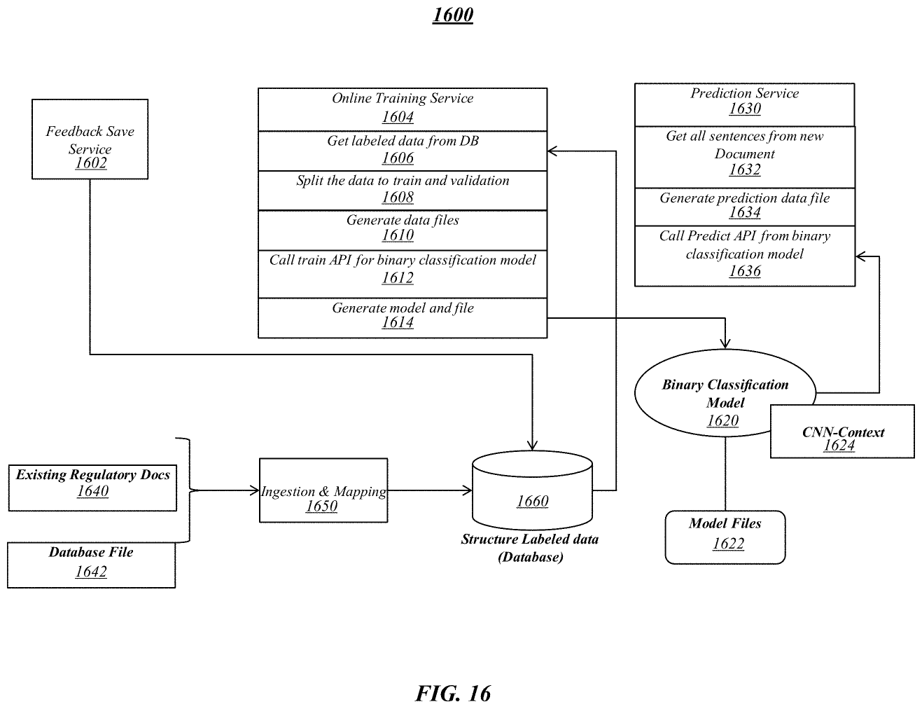

FIG. 16 illustrates an embodiment of a logic flow 1600. Logic flow 1600 may be representative of operations executed by one or more embodiments described herein, such as such as system 1000, apparatus 1100, system 4000, computing platform 6000, and computing platform 700. In some embodiments, logic flow 1600 may be representative of some or all of the operations of a text categorization process, including a text identification model.

Logic flow 1600 may employ a feedback save service 1602, for example, saving feedback data to database 1660 as additional labeled data, or tags. In some embodiments, database (DB) 1660 may include structured labeled data. In various embodiments, logic flow 1600 may include a training process including an online training service 1604. Training process may operate to get labeled data from the database 1606, split the data for training and validation 1608, generate data files 1610, call training API for binary classification model 1612, and generate a model and file 1614 for providing to a binary classification model 1620. In some embodiments, binary classification model 1620 may be or may include a NN or CNN-context 1624. In various embodiments, binary classification model 1620 may include and/or may access model files 1622

In exemplary embodiments, logic flow 1600 may include a prediction process that includes a prediction service 1630, obtaining sentences from a new document 1632, generating a prediction file 1634, and calling a predict API from the binary classification model 1636.

Logic flow 1600 may include one or more pre-stages or steps, including ingesting and mapping 1650 existing regulatory documents 1640 and/or database file 1642. For example, existing regulatory documents 1640 may be ingested, mapped to get the labels at sentence level, and the resulting data stored in database 1660.

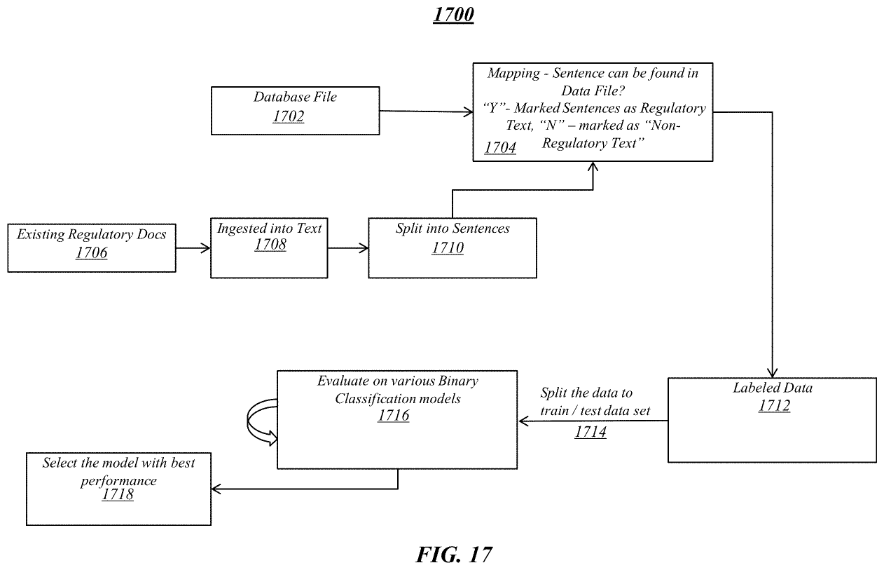

FIG. 17 illustrates an embodiment of a logic flow 1700. Logic flow 1700 may be representative of operations executed by one or more embodiments described herein, such as system 1000, apparatus 1100, system 4000, computing platform 6000, and computing platform 700. In some embodiments, logic flow 1700 may be representative of some or all of the operations of a text categorization process, including a text evaluation process.

At block 1702, logic flow 1700 may access a database file (for instance, a comma delimited file or Microsoft® Excel® file) of regulatory obligations. At block 1704, logic flow 1700 may determine whether a sentence may be found in the data file. If the sentence can be found in the data file, logic flow 1700 may mark the sentences as regulatory text; otherwise, the sentences may be marked as non-regulatory text. Logic flow 1700 may access existing regulatory documents 1706 to be ingested as text 1708 and split into sentences (statements) 1710, for example, to be used in determination step 1704.

The mapping information from determination step 1704 may be stored or otherwise provided as labeled data 1712. Logic flow 1700 may split the labeled data into training and/or testing data sets 1714 for evaluation based on various evaluation models 1716, such as a binary classification model. In some embodiments, logic flow 1700 may select the model with the best performance 1718 for use in a text categorization process.

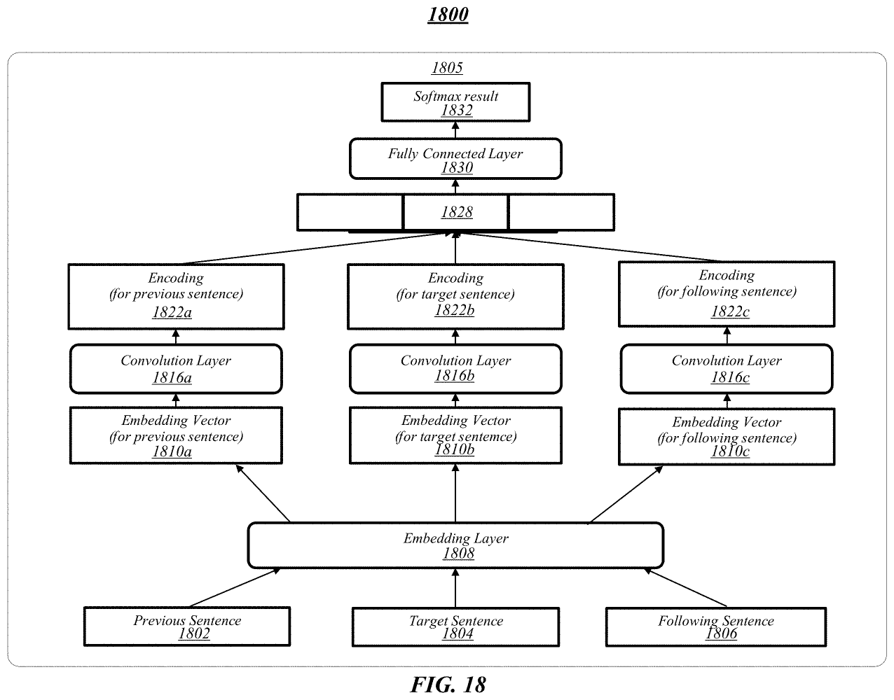

FIG. 18 illustrates an example of an operating environment 1800 that may be representative of various embodiments. The operating environment 1800 depicted in FIG. 8 may implement text categorization processes according to various embodiments, particularly a multi-channel CNN. In some embodiments, performance of a text categorization process may be improved by inputting the context of one or more sentences preceding and/or following a target sentence.

As shown in FIG. 8, a target sentence 1804, previous sentence 1802, and a following sentence 1806 may be provided to an embedding layer 1808. CNN 1805 may include multiple channels for processing of sentences 1802, 1804, and/or 1806. Each channel may include an embedding vector 1810a-c, convolution layer 1816a-c, and/or encoding 1822a-n. The output of each channel may be concatenated 1828 and then provided to a fully connected layer 1830 to generate a result 1832 (for instance, a softmax result).

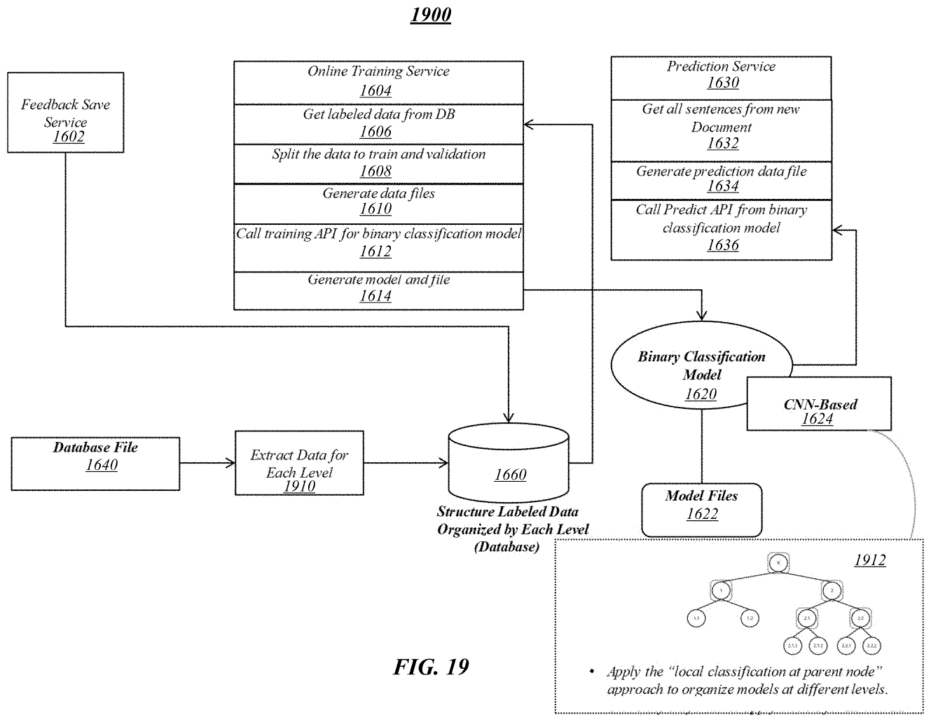

FIG. 19 illustrates an embodiment of a logic flow 1900. Logic flow 1900 may be representative of some or all of the operations executed by one or more embodiments described herein, such as system 1000, apparatus 1100, system 4000, computing platform 6000, and computing platform 700. In some embodiments, logic flow 1900 may be representative of some or all of the operations of a text categorization process that includes a multi-level (for instance, L1/L2/L3) classification process based on a modified logic flow 1600. As shown in FIG. 19, logic flow 1900 may extract data for each level from database file 1640. Logic flow 1900 may use a CNN-based model, including a textcat spaCy process. At block 1912, logic flow 1900 may apply a local classification at parent node approach to organize models at different levels, for instance, L1-L3 (as opposed to only training an applying models from a limited number of levels, such as only L1 and L2)

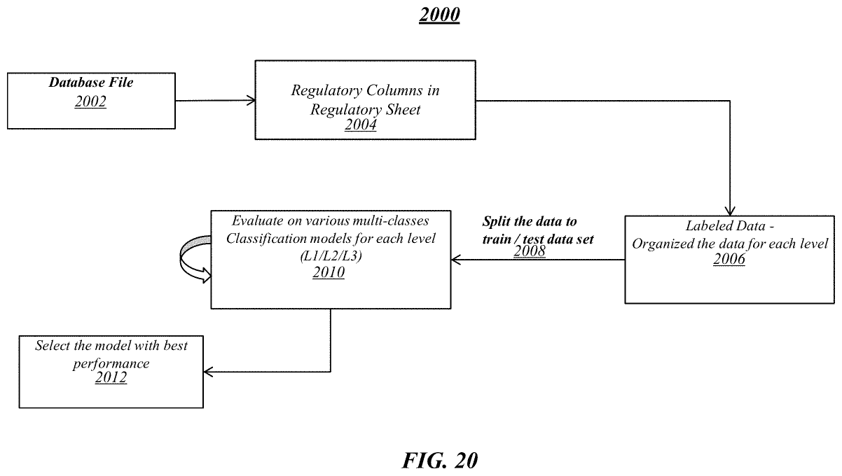

FIG. 20 illustrates an embodiment of a logic flow 2000. Logic flow 2000 may be representative of operations executed by one or more embodiments described herein, such as system 1000, apparatus 1100, system 4000, computing platform 6000, and computing platform 700. In some embodiments, logic flow 2000 may be representative of some or all of the operations of a text categorization process, for example, an evaluation process for a multi-level (L 1/L2/L3) embodiment.

As shown in FIG. 20, logic flow 2000 may access database file 2002 and determine regulatory columns 2004, for example, within a regulatory sheet or other structure of database file 2002. The regulatory columns may be processed as labeled data 2006, for example, organized for each level. The data may be split 2008 into training and/or testing data and evaluated on various multi-class or channel classification models for each level 2010. Logic flow 2000 may select the model with the best performance 2012.

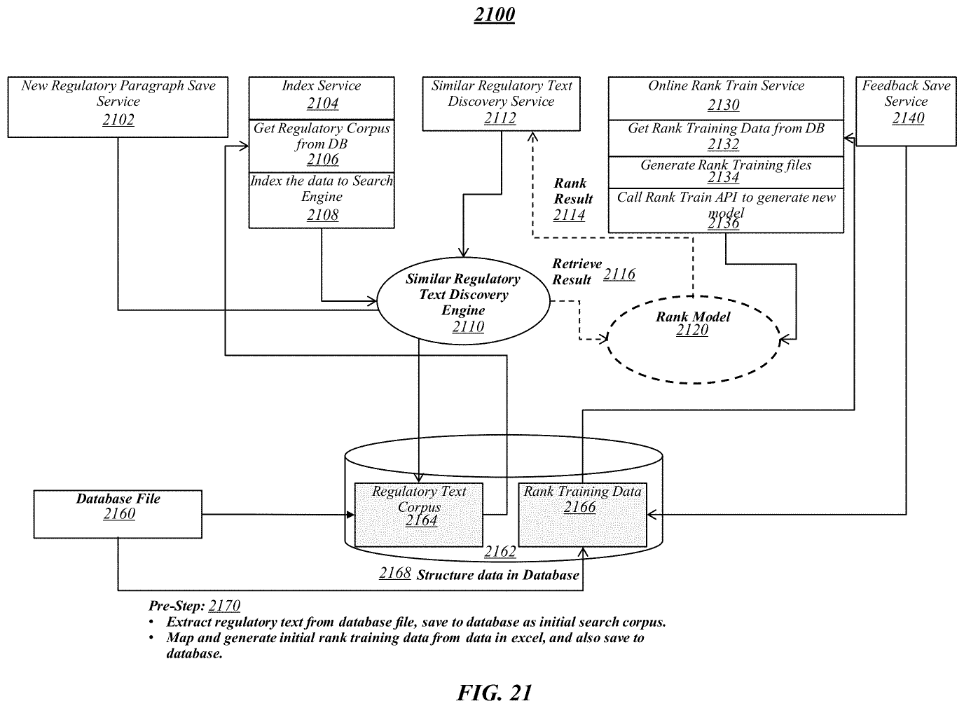

FIG. 21 illustrates an embodiment of a logic flow 2100. Logic flow 2100 may be representative of some or all of the operations executed by one or more embodiments described herein, such as computing device 701. In some embodiments, logic flow 2100 may be representative of some or all of the operations of a text categorization process, more specifically, a process for determining similar text (for instance, a similar regulatory text discovery process or engine).

At block 2102, a new regulatory paragraph save service may save identified regulatory text from new document(s) to regulatory search corpus 2164. Logic flow 2100 may include a search engine (for instance, Solr™) index service 2104 operative to obtain a regulatory corpus from a database 2106 and index the data to a search engine 2108, such as similar regulatory text discovery engine 2110. An online rank training service 2130 may operate to get rank training data from a database 2132, generate rank training files 2134, and call rank training API to generate a new model 2136. The output of online rank training service 2130 may provide or update a rank model 2120. In some embodiments, a rank result 2114 may be provide to a similar regulatory text discovery service 2112. In various embodiments, similar regulatory text discovery engine may retrieve a result 2116 from rank model 2120. Logic flow 2100 may include a feedback save service 2140 operative to save feedback data to database 2162, for example, as additional rank training data. For instance, initially, the search corpus and rank training data are extracted from database file, when new documents are accessed, the new regulatory text will be added in search corpus then re-indexed, and user's feedback will be saved to database as additional rank training data.

In various embodiments, logic flow 2100 may include a pre-step 2170 process operative to extract regulatory text from a database file 2160 for saving to database 2162 as in initial search corpus. Pre-step 2170 may include mapping and generating initial rank training data from data in database file (Excel® file), for example, for saving to database 2162 as rank training data 2166.

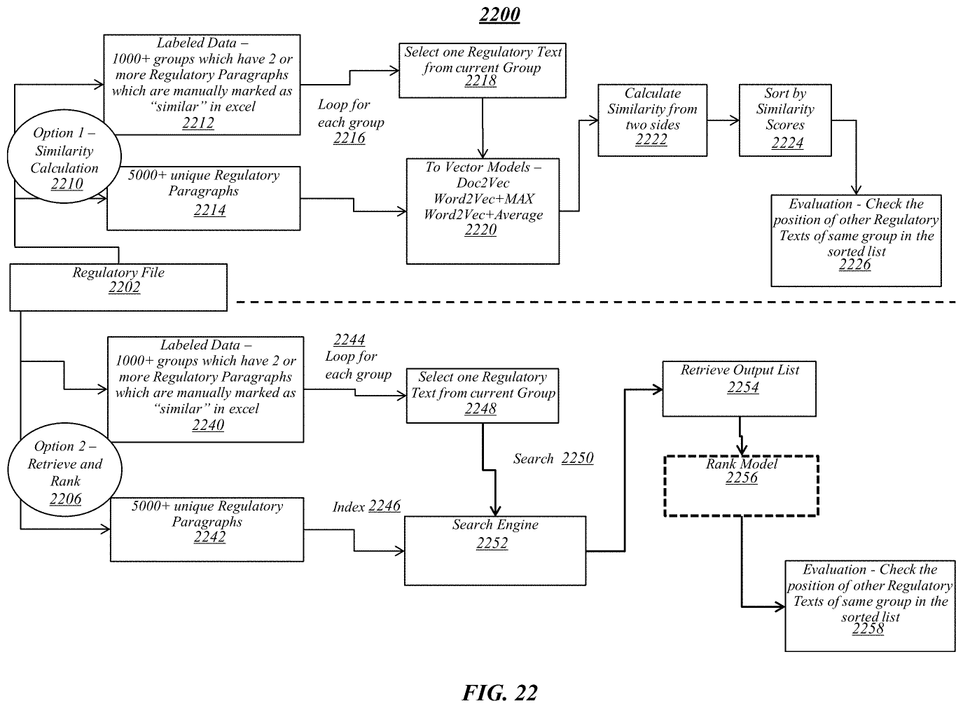

FIG. 22 illustrates an embodiment of a logic flow 2200. Logic flow 2200 may be representative of operations executed by one or more embodiments described herein, such as system 1000, apparatus 1100, system 4000, computing platform 6000, and computing platform 700. In some embodiments, logic flow 2200 may be representative of some or all of the operations of a text categorization process, more specifically, an evaluation process for similar text (for instance, for a similar regulatory text discovery process or engine).

Logic flow 2200 may operate using multiple options, including a similarity calculation 2210 (Option 1) and a retrieve and rank process 2206 (Option 2). In Option 1 2210, labeled data 2212 and regulatory paragraphs 2214 may be determined from regulatory file 2202. Each group of labeled data may be looped 2216 and one regulatory text from a current group may be selected 2218. Vector models 2220 may be determined based on regulatory paragraphs 2214 and selected regulatory text 2218. Similarity may be calculated 2222 from two sides based on vector models 2220, which may be sorted by similarity scores 2224, and evaluated 2226 (for example, by checking the position of other regulatory texts of the same group in a sorted list).

In Option 2 2206, labeled data 2240 and regulatory paragraphs 2242 may be determined from regulatory file 2202. Each group of labeled data may be looped 2244 and one regulatory text from a current group may be selected 2248. Regulatory paragraphs 2242 may be indexed 2246 and provided to a search engine 2252. Selected regulatory text 2248 may be searched 2250 and provided to search engine 2252. Output of search engine 2252 may be used to determine an output list 2254 for a rank model 2256, which may be evaluated 2258 (for example, by checking the position of other regulatory texts of the same group in a sorted list).

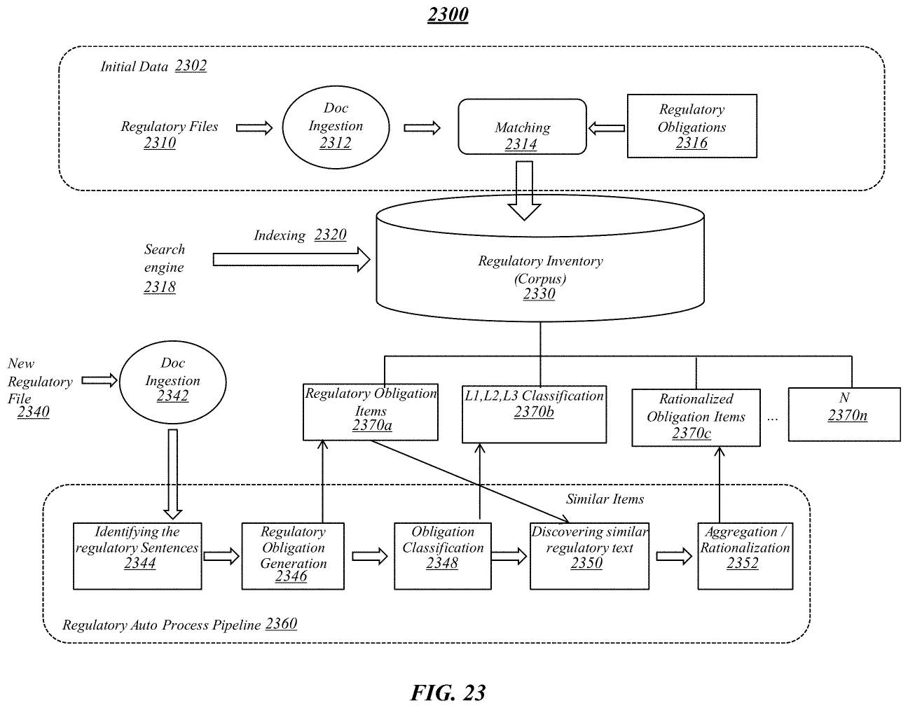

FIG. 23 illustrates an embodiment of a logic flow 2300. Logic flow 2300 may be representative of operations executed by one or more embodiments described herein, such as system 1000, apparatus 1100, system 4000, computing platform 6000, and computing platform 700. In some embodiments, logic flow 2300 may be representative of some or all of the operations of a text inventory maintenance process.

Logic flow 2300 may include an initial data 2302 process that includes accessing regulatory files 2310 for document ingestion 2312. The output of document ingestion 2312 and regulatory obligations may be provided to a matching 2314 process. The output of matching process 2314 may be stored in a regulatory inventory (corpus) 2330. In some embodiments, a search engine (for instance, Solr™) may perform indexing 2320 stored in regulatory inventory 2330.

In various embodiments, logic flow 2300 may include a regulatory auto process pipeline 2360 operative to receive the output of doc ingestion 2342 performed on a new regulatory file 2340. Pipeline 2360 may operate to identify regulatory sentences 2344, generate regulatory obligations 2346, classify obligations 2348, discover similar regulatory text 2350, and/or perform aggregation and/or rationalization 2352. Certain output of pipeline 2360, such as regulatory obligation items 2370a, level classification 2370b, rationalized obligation items 2370c, and/or the like may be stored in regulatory inventory 2330.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible.

What is claimed is:

1. An apparatus, the apparatus comprising:
memory; and
logic circuitry coupled with the memory to:
parse statements in one or more documents;
infer one or more requirements in statements in the one or more documents based on prior training;
access a set of existing controls;
correlate the one or more requirements inferred from the one or more documents with the set of existing controls;
associate a set of the one or more requirements with the set of existing controls based on correlation of each requirement in the set of the one or more requirements with an existing control in the set of existing controls; and
store the set of the one or more requirements in the memory in a data structure to associate each requirement in the set of the one or more requirements with one or more of the existing controls in the set of existing controls.

2. The apparatus of claim 1, the logic circuitry to further interact with a user to verify that the one or more requirements inferred from the one or more document are requirements.

3. The apparatus of claim 1, the logic circuitry to further store a second set of requirements that do not correlate with existing controls in the set of existing controls.

4. The apparatus of claim 3, wherein the second set of requirements is stored in the data structure.

5. The apparatus of claim 1, the logic circuitry to further receive a new control via manual input in response to an inability to correlate a new requirement of the one or more requirements inferred from the one or more documents.

6. An apparatus, the apparatus comprising:
memory; and
logic circuitry coupled with the memory to:
access documents comprising one or more requirements related to guidelines, codes, standards, regulations, or a combination of one or more thereof;
access analyses of the documents, the analyses including identification of statements in the documents that comprise requirements;
generate training data based on the documents and the analyses to train a natural language processing engine to infer a probability or classification of statements in the one or more documents;
infer one or more requirements in statements in the one or more documents;
compare inference of one or more requirements in statements to requirements identified in the analyses; and
backpropagate the result of comparison of inference of one or more requirements in statements to requirements identified in the analyses to train a machine learning ingestion engine.

7. The apparatus of claim 6, the logic circuitry to further associate one or more tags with each of the documents, the one or more tags to comprise data to identify the documents.

8. The apparatus of claim 7, the tags to associate documents with one or more regulatory requirements, statutory requirements, operational requirements, regulatory agencies, standards organizations, regulatory jurisdictions, geographical locations, or a combination thereof.

9. The apparatus of claim 6, further comprising a data structure in the memory, the data structure comprising words or word vectors associated with requirements, words or word vectors associated non-obligatory statements, combinations of words or word vectors associated with requirements, combinations of words or word vectors associated with non-obligatory statements, or a combination thereof.

10. The apparatus of claim 6, wherein the one or more documents and analyses are associated with a single regulatory jurisdiction.

11. The apparatus of claim 10, wherein the one or more documents and analyses further comprise industry standards, cybersecurity standards, operational procedures, or a combination thereof, associated with or related to regulatory requirements in the single regulatory jurisdiction.

12. An apparatus, the apparatus comprising:
memory; and
logic circuitry coupled with the memory to:
organize controls into groups, each group associated with a hardware resource;
engage robotics to access the hardware resource, wherein engagement of robotics comprises initiating code and a robotic mechanism to physically manipulate and to access information in the hardware resource;
receive information collected from the hardware resource;
analyze the information collected from the hardware resource to determine differences between the information collected from the hardware resource and information expected based on a control associated with the hardware resource;
infer one or more remedial actions based on the differences; and
perform the one or more remedial actions.

13. The apparatus of claim 12, wherein receipt of information collected from the hardware resource comprises receipt of information via interpretation logic circuitry and a network connection.

14. The apparatus of claim 12, wherein the remedial actions comprise a comprise initiating code and a robotic mechanism to physically manipulate and access the hardware resource.

15. The apparatus of claim 14, wherein the remedial actions comprise initiating code and a robotic mechanism to physically manipulate and to update the hardware resource, wherein updating the hardware resource comprises changing a hardware component of the hardware resource, updating a software application installed on a hardware resource, updating a configuration of the hardware resource, updating settings of a hardware resource, uninstalling a software application from a hardware resource, uninstalling a hardware component of the hardware resource, or a combination thereof.

16. The apparatus of claim 12, the logic circuitry to autonomously access multiple hardware resources to verify implementation of controls.

17. The apparatus of claim 16, the logic circuitry to autonomously update multiple hardware resources in response to determination of differences between actual configurations and settings and expected configurations and settings based on controls associated with the multiple hardware resources.

18. The apparatus of claim 16, the logic circuitry to autonomously access and update, as needed, the multiple hardware resources continuously.

19. The apparatus of claim 12, further comprising interpretation logic circuitry, the interpretation logic circuitry to convert raw data into input data for a machine learning model, the raw data provided by robotics including a picture of a screen, a screen shot, a log file, or a combination thereof.

20. The apparatus of claim 19, wherein the interpretation logic circuitry comprises a machine reading service (MRS).

21. The apparatus of claim 12, wherein the controls are associated with one or more regulatory requirements, statutory requirements, operational requirements, regulatory agencies, standards organizations, regulatory jurisdictions, geographical locations, or a combination thereof.

22. The apparatus of claim 12, wherein the controls are associated with industry standards, cybersecurity standards, or a combination thereof, associated with or related to regulatory requirements in the single regulatory jurisdiction.

23. An apparatus, the apparatus comprising:
memory; and
logic circuitry coupled with the memory to:
access uncorrelated requirements;
infer new controls for the uncorrelated requirements;
infer one or more remedial actions based on the new controls; and
perform the one or more remedial actions.

24. The apparatus of claim 23, the logic circuitry to further determine uncorrelated controls, controls that do not correlate to requirements, and retire the uncorrelated controls.

25. The apparatus of claim 23, the logic circuitry to further:
infer a risk associated with one of the uncorrelated requirements;
determine if the risk exceeds a risk threshold; and
if the risk exceeds the risk threshold, infer one or more new controls to correlate with the one of the uncorrelated requirements to mitigate the risk.

26. The apparatus of claim 25, wherein the remedial actions comprise initiating code and a robotic mechanism to physically manipulate and to update a hardware resource, wherein updating the hardware resource comprises changing a hardware component of the hardware resource, updating a software application installed on the hardware resource, updating a configuration of the hardware resource, updating settings of the hardware resource, uninstalling a software application from the hardware resource, uninstalling a hardware component of the hardware resource, or a combination thereof.

27. The apparatus of claim 23, the logic circuitry to autonomously access controls mapped to requirements and uncorrelated requirements and infer new controls for the uncorrelated requirements.

28. The apparatus of claim 27, the logic circuitry to autonomously infer the one or more remedial actions based on the new controls; and perform the one or more remedial actions, wherein the one or more remedial actions comprise engagement of robotics.

29. The apparatus of claim 27, the logic circuitry to autonomously access and update, as needed, the multiple hardware resources continuously.

30. The apparatus of claim 23, wherein inference of new controls for the uncorrelated requirements comprises creating input data for at least one machine learning engine based on an uncorrelated requirement; and identifying a new control by the at least one machine learning engine based on the input data.

31. The apparatus of claim 23, wherein the controls are associated with one or more regulatory requirements, statutory requirements, operational requirements, regulatory agencies, standards organizations, regulatory jurisdictions, geographical locations, or a combination thereof.

32. The apparatus of claim 23, wherein the controls are associated with industry standards, cybersecurity standards, or a combination thereof, associated with or related to regulatory requirements in the single regulatory jurisdiction.

33. The apparatus of claim 23, the logic circuitry to further receive a new control via manual input in response to an inability to infer a new control for one or more of the uncorrelated requirements.
